(19) United States
(12) Patent Application Publication
(10) Pub. No.: US 2026/0086700 A1
(43) Pub. Date: Mar. 26, 2026

(54) DEVICE CONTROL METHOD, CONTROL DEVICE, SYSTEM, READABLE STORAGE MEDIUM, AND CHIP

(71) Applicant: HUAWEI TECHNOLOGIES CO., LTD., Shenzhen (CN)

(72) Inventor: Wenhao Wu, Shenzhen (CN)

(73) Assignee: HUAWEI TECHNOLOGIES CO., LTD., Shenzhen (CN)

(21) Appl. No.: 19/407,906

(22) Filed: Dec. 3, 2025

Related U.S. Application Data
(63) Continuation of application No. PCT/CN2024/100125, filed on Jun. 19, 2024.

(30) Foreign Application Priority Data
Nov. 10, 2023 (CN) 202311499520.7

(51) Int. Cl. G06F 3/0484; G06F 3/04815; G06F 3/0482; G06F 3/0488; G06F 40/30

(52) U.S. Cl. CPC G06F 3/0484; G06F 3/04815; G06F 3/0482; G06F 3/0488; G06F 40/30

(57) ABSTRACT

This application provides a device control method, a control device, a system, a readable storage medium, and a chip, relating to the field of smart home technologies. The method is applied to a control device, and includes: displaying a display interface including spatial information, where the spatial information includes at least one area range; determining a first area range from the at least one area range based on a first control operation; determining a target area range from the at least one area range based on a second control operation and the first area range, where the first area range is the same as or different from the target area range; and controlling a corresponding electronic device in the target area range based on the second control operation.

### CROSS-REFERENCE TO RELATED APPLICATIONS

This application is a continuation of International Application No. PCT/CN2024/100125 filed on Jun. 19, 2024, which claims priority to Chinese Patent Application No. 202311499520.7, filed on Nov. 10, 2023. The disclosures of the aforementioned applications are incorporated herein by reference in its entirety.

### TECHNICAL FIELD

This application relates to the field of smart home technologies, and in particular, to a device control method, a control device, a system, a readable storage medium, and a chip.

### BACKGROUND

In the field of smart home technologies, a smart home system includes a control device and various smart home devices that establish connections to the control device by using an internet of things technology. Users can implement remote control, intelligent management, and the like on the various smart home devices by using a device management application in the control device.

Currently, to help users control a plurality of smart home devices at the same time, a device management application typically adopts a scene-based centralized control mode. In an embodiment, the plurality of smart home devices are set in a same scene mode, and once users trigger the scene, a plurality of types of or cross-type devices can be controlled without operating each product device one by one. However, such an approach allows users to operate a plurality of devices in a single operation, users need to define scenes in advance and add corresponding smart home devices in each scene, resulting in high initial operational costs for users. In addition, when users want to control and adjust one or more devices in the smart home devices, they need to perform a cumbersome search operation on a scene-based centralized control operation interface to locate the target device. This makes device management and control inefficient, and delivers poor user experience.

### SUMMARY

This application provides a device control method, a control device, a system, a readable storage medium, and a chip, to resolve a problem in the conventional technology that when a user controls and searches for a target device by using a control device, operation costs are high and operations are complex because management and control performed by the control device on an electronic device are not intelligent enough.

To achieve the foregoing objective, the following technical solutions are used in this application.

According to a first aspect, a device control method is provided, applied to a control device. The method includes: displaying a display interface including spatial information, where the spatial information includes at least one area range; determining a first area range from the at least one area range based on a first control operation; determining a target area range from the at least one area range based on a second control operation and the first area range, where the first area range is the same as or different from the target area range; and controlling a corresponding electronic device in the target area range based on the second control operation.

According to the device control method provided in the first aspect of this application, the control device determines the first area range based on the first control operation of a user, and then determines the target area range based on the determined first area range and the second control operation. In other words, the control device can further determine, by using the second control operation, whether the target area range that the user wants to control is the first area range indicated by the first control operation, or another area range different from or associated with the first area range. In this manner, the target area range that needs to be controlled by the user and the electronic device in the target area range can be more accurately determined, to implement precise control.

In addition, the control operation in this method is performed based on the spatial information displayed on the display interface, so that the user can conveniently and quickly perform intelligent control on one or more devices in the target area range in an intuitive and natural manner. This simplifies an operation procedure, improves interaction efficiency of selecting the target device and controlling the target device in a smart home scene, and improves user experience.

In an embodiment, the determining the first area range from the at least one area range based on the first control operation includes: determining, based on the first control operation, projection coordinates at which the first control operation is projected onto the spatial information; and when the projection coordinates have a corresponding area range, determining the area range corresponding to the projection coordinates as the first area range; or when the projection coordinates have no corresponding area range, determining an area range adjacent to the projection coordinates as the first area range.

As described above, the spatial information includes the at least one area range, and each area range corresponds to respective projection coordinates. In other words, there is a correspondence between the area range and the projection coordinates, and the control device can determine the first area range based on the projection coordinates at which the first control operation is projected onto the spatial information.

When the control device receives the first control operation, if the projection coordinates at which the first control operation is projected onto the spatial information have the corresponding area range, the control device determines the area range corresponding to the projection coordinates as the first area range; or if the projection coordinates at which the first control operation is projected onto the spatial information have no corresponding area range, determines the area range adjacent to the projection coordinates as the first area range.

In an embodiment, the determining the target area range from the at least one area range based on the second control operation and the first area range includes: performing semantic analysis on a control instruction in the second control operation; and when the control instruction includes orientation reference information, determining the target area range based on the orientation reference information and the first area range.

The orientation reference information is related content that describes orientation information, and includes but is not limited to “here”, “this room”, “elsewhere”, “other rooms”, “around”, “next to”, “nearby”, and the like. When the control instruction includes the orientation reference information and does not include the orientation reference information, the control instruction may express completely different control processes. The control instruction included in the second control operation received by the control device may include the orientation reference information, or may not include the orientation reference information. Based on this, after receiving the second control operation, the control device needs to analyze the control instruction in the second control operation, determine whether the control instruction includes the orientation reference information, and then determine the target area range based on an analysis result and with reference to the first area range.

In an embodiment, when the control instruction in the second control operation includes the orientation reference information, if the orientation reference information is “other rooms”, other area ranges than the first area range are determined as the target area range. In this case, the first area range is different from the target area range, and the target area range does not include the first area range.

In some embodiments, the method further includes: when the control instruction does not include the orientation reference information, determining the first area range as the target area range.

In an embodiment, when the control instruction does not include the orientation reference information, the control device considers by default that the target area range that needs to be controlled is the initially determined first area range. In this case, the first area range is the same as the target area range.

In some embodiments, the method further includes: when the control instruction does not include the orientation reference information, determining an upper-level area range of the first area range as the target area range.

This embodiment is another implementation in which the control instruction does not include the orientation reference information, and is applicable to an application scene in which the control instruction includes “implicit” orientation reference information. In this case, the control device determines the upper-level area range of the first area range as the target area range, to satisfy a use requirement of the user. In this case, the first area range is different from the target area range, and the target area range is a larger range including the first area range.

In some embodiments, the spatial information includes: a floor plan of a residential layout; a three-dimensional model diagram of a residential layout; or a three-dimensional model diagram of soft furnishings layout information within a residential environment.

In some other embodiments, the spatial information may alternatively be a topographic distribution diagram of an area of a city, or the like.

In some embodiments, the area range includes: a dot area range corresponding to the projection coordinates at which the first control operation is projected onto the spatial information; a two-dimensional area range or a three-dimensional area range corresponding to the projection coordinates at which the first control operation is projected onto the spatial information; or an area range indicated by area identification information corresponding to the projection coordinates at which the first control operation is projected onto the spatial information.

In an embodiment, the dot area range may be any point in two-dimensional spatial information or three-dimensional spatial information. The two-dimensional area range may be a preset plane range around any point in the spatial information. The point may be a center point of the preset plane range, for example, a center of a circular area range; or may be any point in the preset plane range, for example, a vertex of a rectangular area range. The three-dimensional area range may be a preset spatial range around any point in the spatial information. The point may be a center point of the preset spatial range, for example, a center of a sphere; or may be any other point in the preset spatial range, for example, a vertex of a cone. The area range indicated by the area identification information may be a preset area range corresponding to a name of a spatial area or a name of an orientation reference object. For example, an area range indicated by an area ID “living room sofa” is a preset area range corresponding to “living room sofa”; and an area range indicated by an area ID “bedroom” is a preset area range corresponding to “bedroom”.

In some embodiments, the determining the first area range from the at least one area range based on the first control operation includes: receiving a selection operation performed by the user on N area ranges in the spatial information; receiving a cancellation operation performed by the user on M of the N area ranges; and determining N-M area ranges as the first area range, where N≥M≥1.

In an embodiment, the determining the first area range from the at least one area range based on the first control operation further includes: receiving a tap operation performed by the user on the N area ranges in the spatial information, and determining the N area ranges as the first area range; or the control device receives a swiping selection operation performed by the user on a first area in the spatial information, and determines N area ranges included in the first area as the first area range, where N≥1.

In an embodiment, the control device may determine one or more first area ranges based on a user operation, to control a plurality of area ranges subsequently.

In some embodiments, after the determining the first area range from the at least one area range based on the first control operation, and before the receiving the second control operation, the method further includes: extracting a candidate control instruction related to the first area range; and displaying an element control of the candidate control instruction on the display interface, where the element control indicates the user to input the control instruction based on content corresponding to the element control.

In an embodiment, the user may trigger corresponding control by controlling an operation option (for example, tap On/Off, or adjust a slider) corresponding to the element control or saying corresponding words in the element control.

In an embodiment, the second control operation includes a voice control operation or a touch control operation.

In an embodiment, the displaying the display interface including the spatial information includes: determining a position orientation of the control device in a physical space; and controlling a display direction of the spatial information in a first direction of the control device to be consistent with the position orientation of the control device.

In some embodiments, the method further includes: when the position orientation of the control device in the physical space changes, adjusting the display direction of the spatial information on the display interface of the control device based on a changed position orientation.

In this manner, the user can more intuitively map the spatial information on the display interface, for example, the three-dimensional model diagram of the house structure of the home environment or the floor plan of the house structure of the home environment, to the real physical space, and the view display direction of the spatial information can be adaptively adjusted based on the position orientation of the control device in the physical space, to improve user experience.

According to a second aspect, a device control apparatus is provided, applied to a control device. The apparatus includes: a display module, configured to display a display interface including spatial information, where the spatial information includes at least one area range; a first determining module, configured to determine a first area range from the at least one area range based on a first control operation; a second determining module, configured to determine a target area range from the at least one area range based on a second control operation and the first area range, where the first area range is the same as or different from the target area range; and a control module, configured to control a corresponding electronic device in the target area range based on the second control operation.

According to a third aspect, a control device is provided, including a memory, a processor, and a computer program stored in the memory and capable of running on the processor. When the computer program is executed by the processor, the method shown in the first aspect is implemented.

According to a fourth aspect, a device control system is provided, including a control device and a plurality of electronic devices connected to the control device. The control device is configured to perform the method shown in the first aspect.

According to a fifth aspect, a computer-readable storage medium is provided. The computer-readable storage medium stores a computer program. When the computer program is executed by a processor, the method shown in the first aspect is implemented.

According to a sixth aspect, a chip is provided. The chip includes a processor and a memory. The memory stores a computer program. When the computer program is executed by the processor, the method shown in the first aspect is implemented.

It may be understood that, for beneficial effects of the second aspect to the sixth aspect, refer to related descriptions in the first aspect. Details are not described herein again.

### BRIEF DESCRIPTION OF DRAWINGS

FIG. 1 is a diagram of a structure of a smart home system according to an embodiment of this application;

FIG. 2A is a diagram of a structure of a smart home system according to another embodiment of this application;

FIG. 2B is a diagram of a structure of a smart home system according to still another embodiment of this application;

FIG. 3 is a diagram of a structure of a control device according to an embodiment of this application;

FIG. 4A(a) to FIG. 4A(d) are a diagram of a scene in which a control device controls a single-product device in smart home devices according to an embodiment of this application;

FIG. 4B(a) to FIG. 4B(c) are a diagram of a scene in which a control device controls smart home devices in a scene-based centralized control manner according to an embodiment of this application;

FIG. 5 is a schematic interaction flowchart of a device control method according to an embodiment of this application;

FIG. 6 is a diagram of a structure of spatial information according to an embodiment of this application;

FIG. 7A is a diagram of an area range according to an embodiment of this application;

FIG. 7B is a diagram of an area range according to another embodiment of this application;

FIG. 7C is a diagram of an area range according to still another embodiment of this application;

FIG. 8A(a) and FIG. 8A(b) are a diagram of a scene in which spatial information is displayed based on a first orientation according to an embodiment of this application;

FIG. 8B(a) and FIG. 8B(b) are a diagram of a scene in which spatial information is displayed based on a second orientation according to an embodiment of this application;

FIG. 9A is a diagram of correspondences between projection coordinates and dot area ranges according to an embodiment of this application;

FIG. 9B is a diagram of correspondences between projection coordinates and two-dimensional/three-dimensional area ranges according to an embodiment of this application;

FIG. 9C is a diagram of correspondences between projection coordinates and area ranges corresponding to area IDs according to an embodiment of this application;

FIG. 10A(a) and FIG. 10A(b) are a diagram of a scene in which a control device determines a first area range based on a first control operation according to an embodiment of this application;

FIG. 10B(a) and FIG. 10B(b) are a diagram of a scene in which a control device determines a first area range based on a first control operation according to another embodiment of this application;

FIG. 10C is a diagram of a scene in which a control device determines a first area range based on a first control operation according to still another embodiment of this application;

FIG. 10D(a) and FIG. 10D(b) are a diagram of a scene in which a control device determines a first area range based on a first control operation according to yet another embodiment of this application;

FIG. 10E is a diagram of a scene in which a control device determines a first area range based on a first control operation according to a further embodiment of this application;

FIG. 11A is a diagram of displaying a control interface by a control device in response to a first control operation according to an embodiment of this application;

FIG. 11B is a diagram of displaying a control interface by a control device in response to a first control operation according to another embodiment of this application;

FIG. 12A is a diagram of correspondences between electronic device types and control instruction sets according to an embodiment of this application;

FIG. 12B is a diagram of a correspondence between an electronic device and spatial information according to an embodiment of this application;

FIG. 13A is a diagram of a scene in which a control device determines a target area range according to an embodiment of this application;

FIG. 13B is a diagram of a scene in which a control device determines a target area range according to another embodiment of this application;

FIG. 13C is a diagram of a scene in which a control device determines a target area range according to still another embodiment of this application;

FIG. 13D is a diagram of an area range hierarchical relationship according to an embodiment of this application;

FIG. 14A(a) and FIG. 14A(b) are a diagram of a scene in which a control device controls an electronic device in a target area range according to an embodiment of this application;

FIG. 14B(a) and FIG. 14B(b) are a diagram of a scene in which a control device controls an electronic device in a target area range according to another embodiment of this application;

FIG. 15 is a diagram of a structure of a device control apparatus according to an embodiment of this application; and

FIG. 16 is a diagram of a structure of a chip according to an embodiment of this application.

### DESCRIPTION OF EMBODIMENTS

Technical solutions provided in embodiments of this application are described below with reference to accompanying drawings.

It should be understood that, in descriptions of embodiments of this application, “/” indicates “or”, unless otherwise specified. For example, A/B may indicate A or B. The term “and/or” in this specification describes only an association relationship between associated objects, and indicates that three relationships may exist. For example, A and/or B may indicate the following three cases: Only A exists, both A and B exist, and only B exists.

Terms “first” and “second” in embodiments are merely intended for a purpose of description, and shall not be understood as an indication or an implication of relative importance or an implicit indication of a quantity of indicated technical features. Therefore, a feature limited by “first” or “second” may explicitly or implicitly include one or more features. In the descriptions of embodiments, unless otherwise specified, “a plurality of” means two or more.

A smart home system is a residential remote control system. The smart home system uses an advanced computer technology, a network communication technology, an integrated cabling technology, and the like to organically combine various subsystems related to home life, and implements remote control and overall management, so that home life is more comfortable, secure, and convenient, energy and resources can be saved, and quality of life can be improved.

FIG. 1 is a diagram of a structure of a smart home system according to an embodiment of this application. As shown in FIG. 1, the system includes a control device and a plurality of smart home devices (also referred to as electronic devices). The control device is wirelessly connected to the smart home devices, and the smart home devices may be connected or not connected to each other. In addition, wireless connection manners between different devices may be wireless fidelity (Wi-Fi), Bluetooth (BT), or the like. This is not specifically limited in an embodiment.

The smart home device is an object managed and controlled by the control device, and can perform a corresponding control operation according to a control instruction of the control device. For example, the smart home device may be a television, a speaker, a headset, an air purifier, a refrigerator, an air conditioner, a robotic vacuum cleaner, a light, a camera, a router, a power strip, a desk lamp, a router, a humidifier, a socket, an intelligent lock, a water purifier, a treadmill, or the like. The control operation performed by the smart home device according to the control instruction varies with a device type. For example, a control operation performed by the light may be turning on/off the light, adjusting brightness of the light, or the like, a control operation performed by the speaker may be playing/pausing music, and a control operation performed by the air conditioner may be turning on/off the air conditioner, adjusting a temperature, or the like. A type of the smart home device is not limited in embodiments of this application.

The control device plays a management and control role in the smart home system, and can intelligently manage and control the smart home devices by using a device management application (for example, an AI Life application). In an embodiment, the control device may be a portable terminal device with a display, for example, a mobile phone or a tablet computer, or may be a home management device with a display, for example, a central display screen, a smart screen, or a central control panel. It may be understood that, different types of control devices may be connected to the smart home devices in different manners.

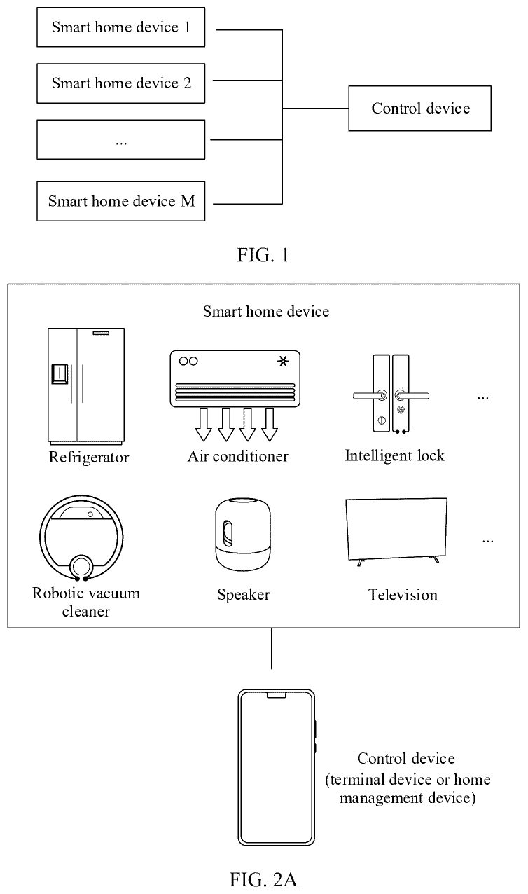

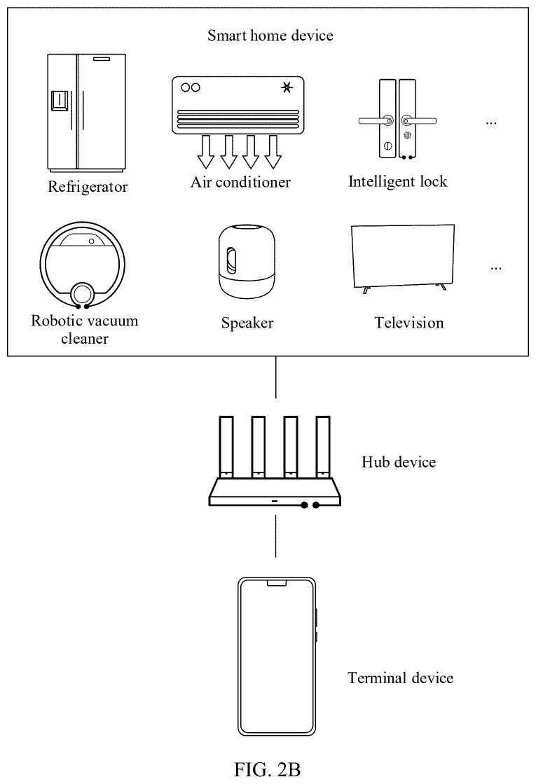

Refer to FIG. 2A. In some embodiments, when the control device is a terminal device or a home management device, the control device may be directly connected to and control the smart home devices.

Refer to FIG. 2B. In some other embodiments, when the control device is a terminal device like a mobile phone or a tablet computer, the control device may be indirectly connected to the smart home devices through a hub device. Based on this, when controlling the smart home devices, the control device needs to perform signaling or data forwarding transmission through the hub device. For example, when controlling the air conditioner to be turned on, the control device needs to first send a turn-on instruction to the hub device, and then the hub device forwards the turn-on instruction to the air conditioner. The hub device may be the home management device mentioned in the foregoing embodiment, or may be a device like a router or a home gateway. This is not limited in embodiments.

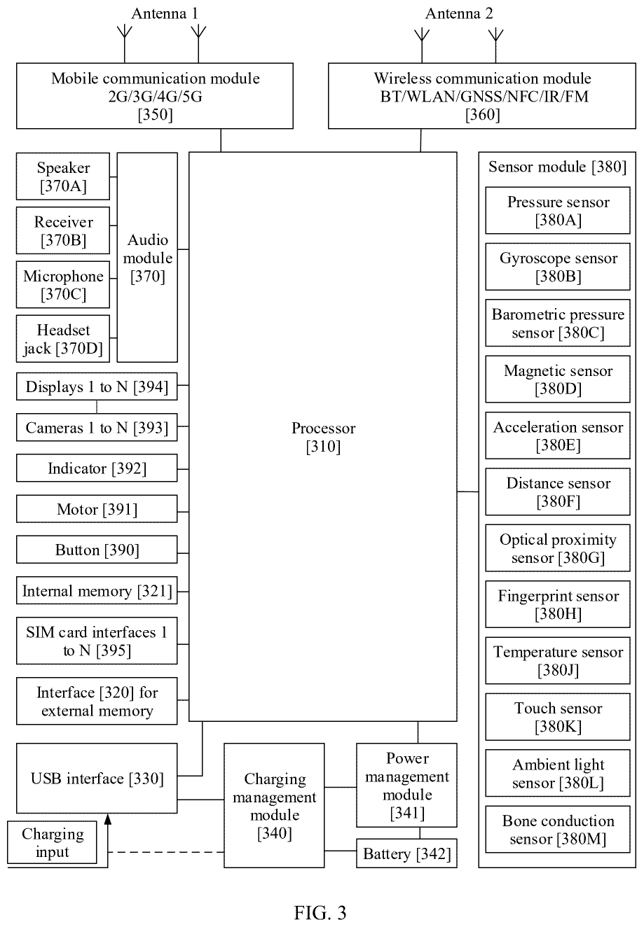

FIG. 3 is a diagram of a structure of a control device according to an embodiment of this application. The control device includes a processor 310, an interface 320 for external memory, an internal memory 321, a universal serial bus (USB) interface 330, a charging management module 340, a power management module 341, a battery 342, an antenna 1, an antenna 2, a mobile communication module 350, a wireless communication module 360, an audio module 370, a speaker 370A, a receiver 370B, a microphone 370C, a headset jack 370D, a sensor module 380, a button 390, a motor 391, an indicator 392, a camera 393, a display 394, a subscriber identification module (SIM) card interface 395, and the like.

It may be understood that, a structure illustrated in embodiments of this application does not constitute a limitation on the control device. In some other embodiments of this application, the control device may include more or fewer components than those shown in the figure, or have some components combined, or have some components split, or have a different component arrangement. The components shown in the figure may be implemented by using hardware, software, or a combination of software and hardware.

The processor 310 may include one or more processing units. For example, the processor 310 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors. The controller may be a nerve center and a command center of the control device. The controller may generate an operation control signal based on an instruction operation code and a time sequence signal, to complete control of instruction reading and instruction execution.

A memory may be further disposed in the processor 310, and is configured to store instructions and data. In some embodiments, the memory in the processor 310 is a cache. The memory may store instructions or data just used or cyclically used by the processor 310. If the processor 310 needs to use the instructions or the data again, the processor 310 may directly invoke the instructions or the data from the memory. This avoids repeated access and reduces waiting time of the processor 310, thereby improving system efficiency.

The charging management module 340 is configured to receive a charging input from a charger. The charger may be a wireless charger or a wired charger. In some embodiments of wired charging, the charging management module 340 may receive a charging input of the wired charger through the USB interface 330. In some embodiments of wireless charging, the charging management module 340 may receive a wireless charging input through a wireless charging coil of the control device. When charging the battery 342, the charging management module 340 may further supply power to the control device through the power management module 341.

The power management module 341 is configured to connect to the battery 342, the charging management module 340, and the processor 310. The power management module 341 receives an input of the battery 342 and/or the charging management module 340, and supplies power to the processor 310, the internal memory 321, the external memory, the display 394, the camera 393, the wireless communication module 360, and the like. The power management module 341 may be further configured to monitor parameters such as a battery capacity, a battery cycle count, and a battery health status (electric leakage or impedance).

A wireless communication function of the control device may be implemented through the antenna 1, the antenna 2, the mobile communication module 350, the wireless communication module 360, a modem processor, a baseband processor, and the like.

The antenna 1 and the antenna 2 are configured to transmit and receive an electromagnetic wave signal. Each antenna in the control device may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 350 may provide a wireless communication solution that is applied to the control device and that includes 2G/3G/4G/5G or the like. The mobile communication module 350 may include at least one filter, a switch, a power amplifier, a low noise amplifier (LNA), and the like. The mobile communication module 350 may receive an electromagnetic wave through the antenna 1, perform processing such as filtering or amplification on the received electromagnetic wave, and transmit the electromagnetic wave to the modem processor for demodulation. The mobile communication module 350 may further amplify a signal modulated by the modem processor, and convert the signal into an electromagnetic wave for radiation through the antenna 1.

In some embodiments, at least a part of functional modules in the mobile communication module 350 may be disposed in the processor 310. In some embodiments, at least a part of functional modules in the mobile communication module 350 may be disposed in a same component as at least a part of modules in the processor 310.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio playing device (which is not limited to the speaker 370A, the receiver 370B, or the like), or displays an image or a video through the display 394. In some embodiments, the modem processor may be an independent component. In some other embodiments, the modem processor may be independent of the processor 310, and is disposed in a same component as the mobile communication module 350 or another functional module.

The wireless communication module 360 may provide a wireless communication solution that is applied to the control device and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 360 may be one or more components integrating at least one communication processing module. The wireless communication module 360 receives an electromagnetic wave through the antenna 2, performs frequency modulation and filtering on an electromagnetic wave signal, and sends a processed signal to the processor 310. The wireless communication module 360 may further receive a to-be-sent signal from the processor 310, perform frequency modulation and amplification on the signal, and convert the signal into an electromagnetic wave for radiation through the antenna 2.

The camera 393 is configured to capture a static image or a video. In some embodiments, the control device may include one or N cameras 393, where N is a positive integer greater than 1.

The display 394 is configured to display an image, a video, and the like, for example, various device management interfaces in embodiments of this application. The display 394 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the control device may include one or N displays 394, where N is a positive integer greater than 1.

The interface 320 for external memory may be configured to connect to an external storage card, for example, a micro SD card, to expand a storage capability of the control device. The external storage card communicates with the processor 310 through the interface 320 for external memory, to implement a data storage function. For example, files such as music and videos are stored in the external storage card.

The internal memory 321 may be configured to store computer-executable program code, and the computer-executable program code includes instructions. The processor 310 runs the instructions stored in the internal memory 321, to perform various function applications and data processing of the control device. The internal memory 321 may include a program storage area and a data storage area. The program storage area may store an operating system, an application required by at least one function (for example, a sound playing function or an image playing function). The data storage area may store data (such as audio data and a phone book) created when the control device is used.

In addition, the internal memory 321 may include a high-speed random access memory, and may further include a nonvolatile memory, for example, at least one magnetic disk storage component, a flash memory component, and a universal flash storage (UFS).

The control device may implement an audio function through the audio module 370, the speaker 370A, the receiver 370B, the microphone 370C, the headset jack 370D, the application processor, and the like.

The audio module 370 is configured to convert a digital audio signal into an analog audio signal for output, and is also configured to convert an analog audio input into a digital audio signal. The audio module 370 may be further configured to encode and decode an audio signal. In some embodiments, the audio module 370 may be disposed in the processor 310, or a part of functional modules of the audio module 370 are disposed in the processor 310.

The speaker 370A, also referred to as a “loudspeaker”, is configured to convert an audio electrical signal into a sound signal. The control device may be used to listen to music or answer a call in a hands-free mode over the speaker 370A. For example, the speaker may play a comparison analysis result provided in embodiments of this application.

The receiver 370B, also referred to as an “earpiece”, is configured to convert an audio electrical signal into a sound signal. When a call is answered or a voice message is received through the control device, the receiver 370B may be put close to a human ear to listen to a voice.

The microphone 370C, also referred to as a “mike” or a “mic”, is configured to convert a sound signal into an electrical signal. When making a call or sending a voice message, a user may make a sound near the microphone 370C through a mouth of the user, to input a sound signal to the microphone 370C. At least one microphone 370C may be disposed in the control device. In some other embodiments, two microphones 370C may be disposed in the control device, to collect a sound signal and implement a noise reduction function. In some other embodiments, three, four, or more microphones 370C may alternatively be disposed in the control device, to collect a sound signal, implement noise reduction, recognize a sound source, implement a directional recording function, and the like.

In some embodiments, the control device may receive, through the microphone 370C, an ultrasonic signal sent by another electronic device, and recognize a frequency and receiving strength of the ultrasonic signal through the processor 310.

The headset jack 370D is configured to connect to a wired headset. The headset jack 370D may be a USB interface 330, or may be a 3.5 mm open mobile terminal platform (OMTP) standard interface or a cellular telecommunications industry association of the USA (CTIA) standard interface.

The sensor module 380 may include a pressure sensor 380A, a gyroscope sensor 380B, a barometric pressure sensor 380C, a magnetic sensor 380D, an acceleration sensor 380E, a distance sensor 380F, an optical proximity sensor 380G, a fingerprint sensor 380H, a temperature sensor 380J, a touch sensor 380K, an ambient light sensor 380L, a bone conduction sensor 380M, and the like.

The button 390 includes a power button, a volume button, and the like. The button 390 may be a mechanical button, or may be a touch button. The control device may receive a button input, and generate a button signal input related to a user setting and function control of the control device.

The motor 391 may generate a vibration prompt. The motor 391 may be configured to provide an incoming call vibration prompt and touch vibration feedback. For example, touch operations performed on different applications (for example, photographing and audio playing) may correspond to different vibration feedback effects. For touch operations performed on different areas of the display 394, the motor 391 may also correspond to different vibration feedback effects.

The indicator 392 may be an indicator light, and may be configured to indicate a charging status and a power change of the control device, or may be configured to indicate a message, a missed call, a notification, and the like.

The SIM card interface 395 is configured to connect to a SIM card. The SIM card may be inserted into the SIM card interface 395 or removed from the SIM card interface 395, to implement contact with or separation from the control device. The control device may support one or N SIM card interfaces, where N is a positive integer greater than 1. The SIM card interface 395 may support a nano-SIM card, a micro-SIM card, a SIM card, and the like. A plurality of cards may be simultaneously inserted into a same SIM card interface 395. The plurality of cards may be of a same type or different types.

Currently, compared with a conventional home appliance system, a smart home system has more devices and functions. With development of smart home technologies, a future smart home system includes more devices and implements more functions of the devices. Therefore, a simpler, more intuitive, and more natural manner is required for control and management.

Generally, to help a user control and manage a smart home device by using a device management application, the user and a control device may exchange control instructions with the smart home device in a manner of voice interaction, touch interaction, and/or the like.

Voice interaction means that the control device indicates the user to have a conversation with the smart home system by speaking, to implement various instructions and queries based on voice recognition and voice synthesis technologies. For example, the user may use a voice command to turn on or off a smart home device like a light, an air conditioner, or a curtain, or query the smart home device for information such as weather, news, and a schedule.

Touch interaction means that the control device indicates the user to interact with the smart home system by touching or displaying a gesture, to implement various settings and adjustments based on a touchscreen or a gesture recognition technology. For example, the user may select related parameters of the smart home device in different modes or scenes by using an icon or a menu on the touchscreen, or adjust parameters such as volume and brightness of a single-product device.

The control device may separately control a single-product device (also referred to as a single device) in the smart home device based on a user operation, or may control a plurality of electronic devices in the smart home device in a centralized manner. The following provides descriptions with reference to examples.

### Example 1: Separate Control of a Single-Product Device Based on a User Operation

A process in which the control device separately controls the single-product device based on the user operation may be as follows: The control device performs an operation like turning on/off or brightness adjustment on a target device in response to a tap operation performed by the user on a control widget button of the target device or a drag operation performed by the user on a slider on a touch interface; or when the user is far away from the control device, the control device performs an operation like turning on/off or brightness adjustment on the target device based on a voice instruction input by the user.

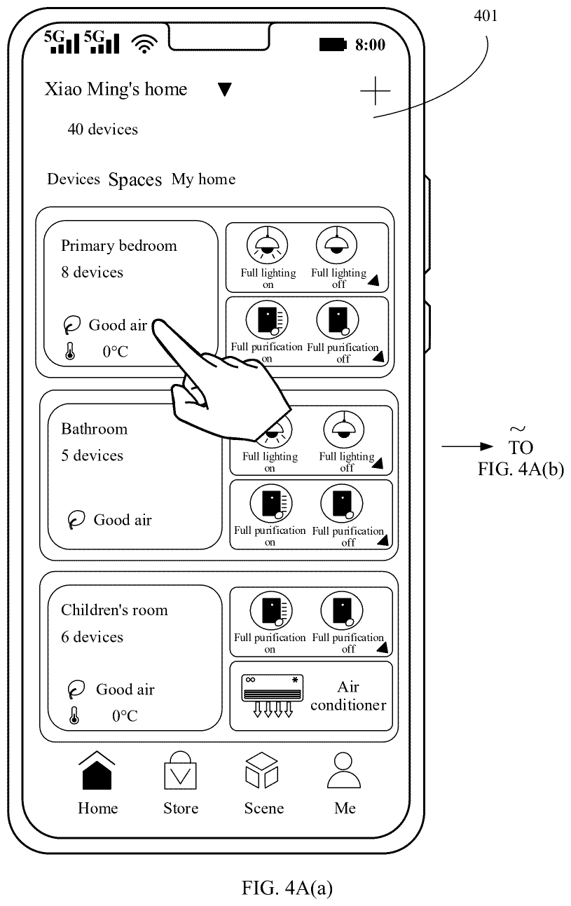

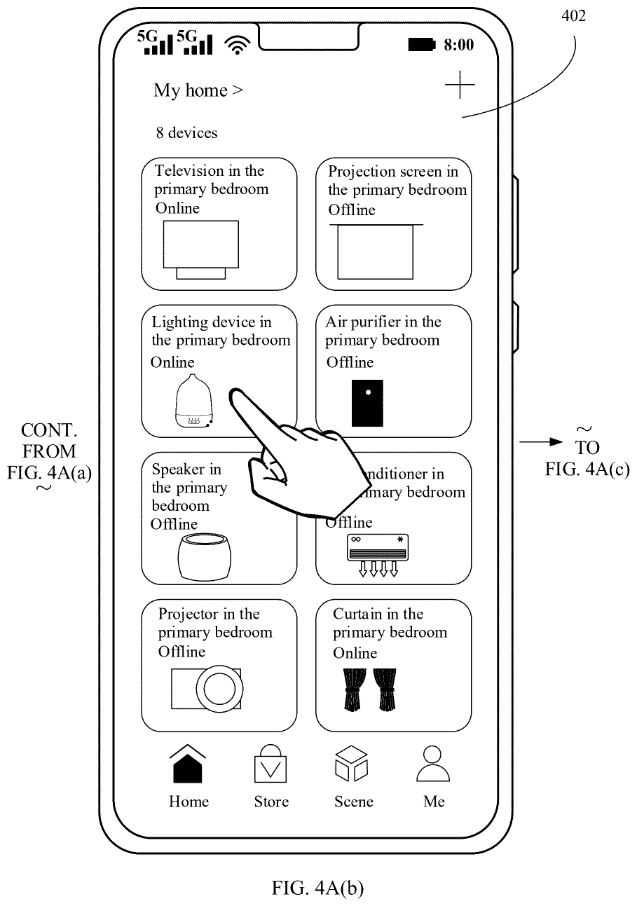

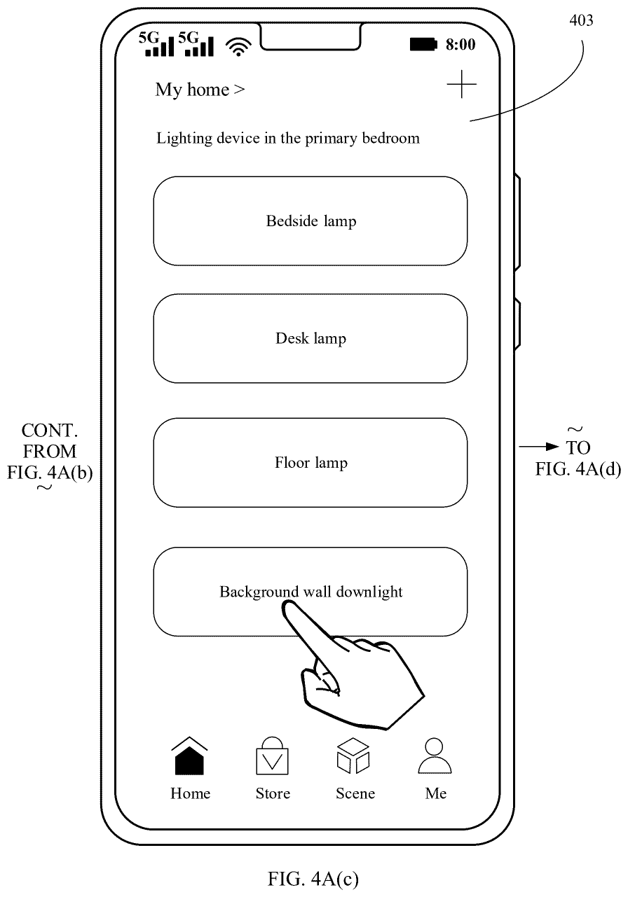

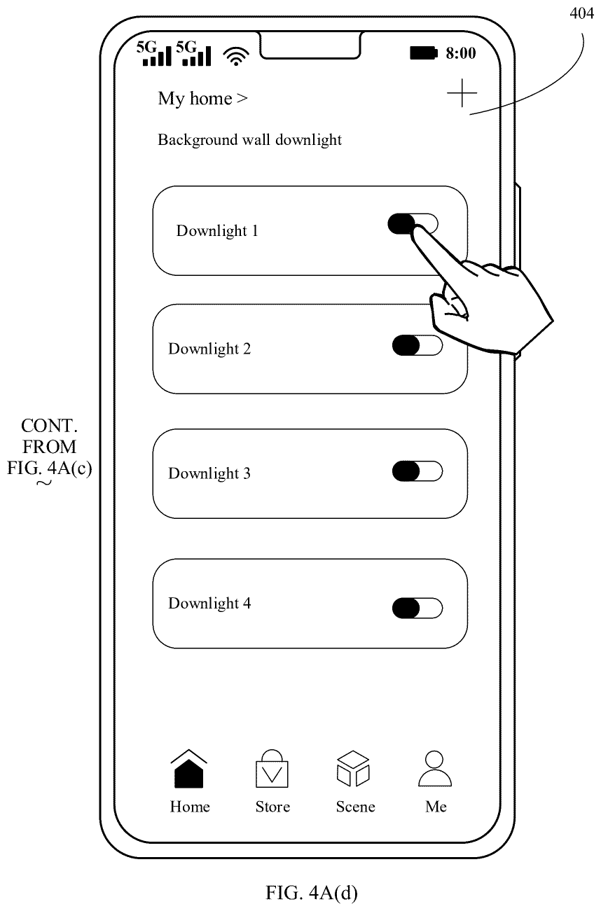

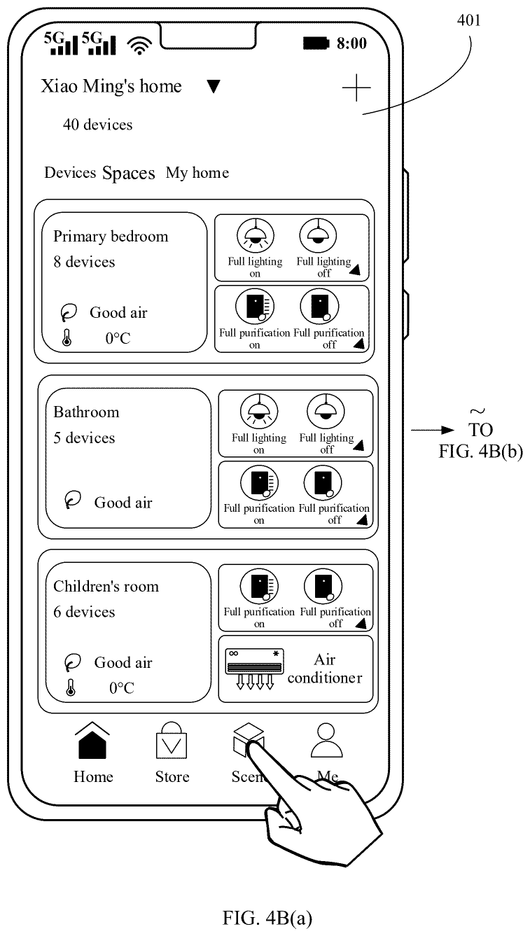

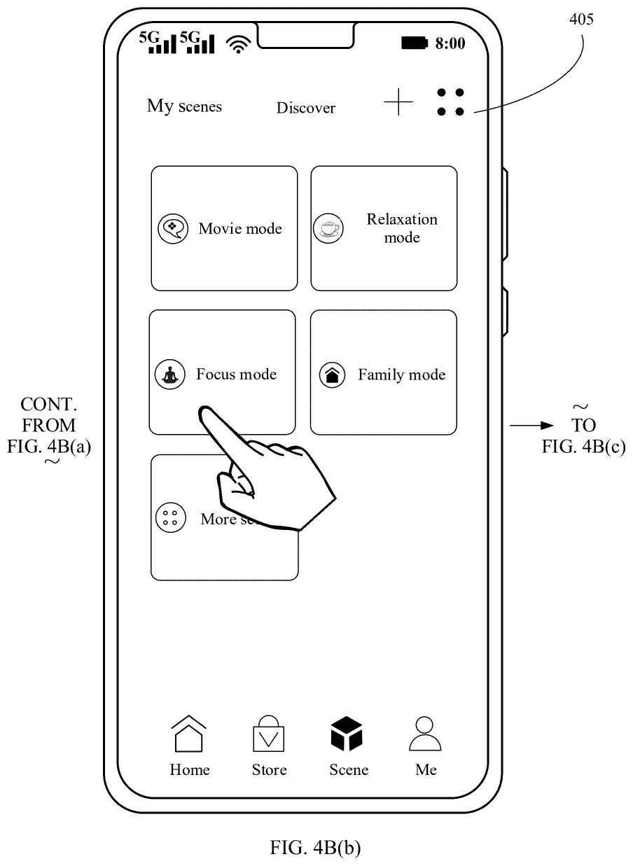

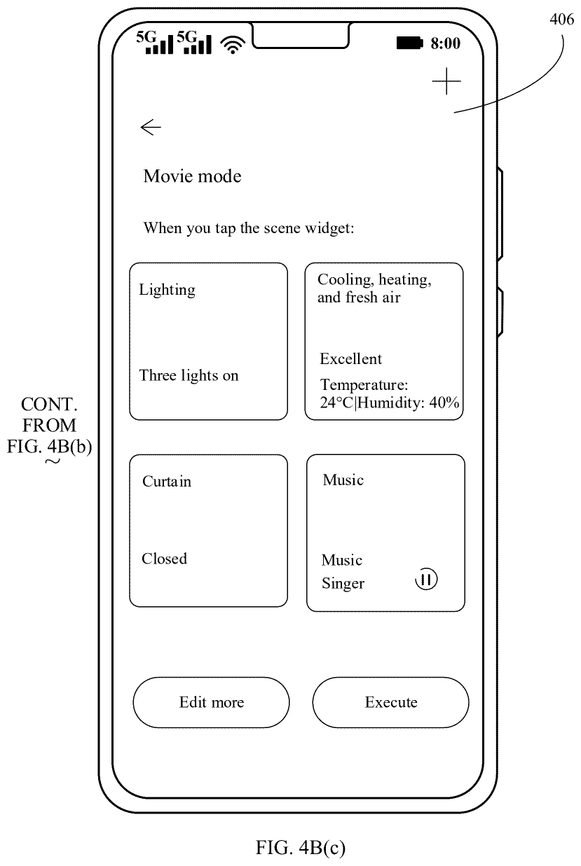

In an embodiment, the control device may complete control on the target device on the touch interface based on the user operation. For example, FIG. 4A(a) to FIG. 4A(d) are a diagram of a process in which a control device controls a single-product device according to embodiments, and relates to a process in which the control device controls to “turn on a background wall downlight in a primary bedroom”. FIG. 4A(a) shows a main interface of a control management application. Operation options of Devices that can be controlled by the device management application, Spaces, and “My home” are displayed on the main interface. It should be understood that the main interface may further include more or fewer operation options. This is not limited in embodiments of this application.

As shown in FIG. 4A(a) to FIG. 4A(d), after the user starts the control management application in the control device, an interface 401 shown in FIG. 4A(a) is displayed. Operation options of different spaces, for example, Primary bedroom, Bathroom, and Children's room, are displayed on the interface 401. The user performs an operation shown in FIG. 4A(a), that is, the user taps an operation option of Primary bedroom, and an interface 402 shown in FIG. 4A(b) is displayed. Operation options of different device types in the primary bedroom, for example, Television in the primary bedroom, Lighting device in the primary bedroom, Speaker in the primary bedroom, and Air conditioner in the primary bedroom, are displayed on the interface 402. The user taps an operation option of Lighting device in the primary bedroom on the interface 402, and the control device displays, in response to the tap operation of the user, an interface 403 shown in FIG. 4A(c). Operation options of lighting devices of different lighting types, for example, Background wall downlight, Desk lamp, Floor lamp, and Bedside lamp, are displayed on the interface 403. The user taps an operation option of Background wall downlight on the interface 403, and the control device displays, in response to the tap operation of the user, an interface 404 shown in FIG. 4A(d). An on/off option corresponding to each background wall downlight is displayed on the interface 404. The user performs a tap operation on the on/off option, and the control device completes, in response to the tap operation, a process of turning on the background wall downlight.

It can be learned that, in the operation process shown in FIG. 4A(a) to FIG. 4A(d), when the control device controls, on the touch interface based on the user operation, to turn on the background wall downlight in the primary bedroom, the user needs to sequentially select Spaces, Primary bedroom, and Lighting device in the primary bedroom on interfaces, find an option corresponding to “Background wall downlight” in the plurality of lighting devices in the primary bedroom, and then select and tap the option to turn on the background wall downlight. In a process of performing the operations, finding the option corresponding to “Background wall downlight” in the plurality of lighting devices in the primary bedroom is the most tedious operation, because the user needs to: read names of different lighting devices one by one, determine whether the name corresponds to the lighting device that the user wants to operate, and after completing determining, tap the option and complete the final control operation.

In an embodiment, the control device may complete control on the target device via voice interaction based on the user operation. For example, in a scene in which the control device controls to “turn on a background wall downlight in a primary bedroom”, the user needs to say “turn on the background wall downlight in the primary bedroom” to the control device in a voice interaction mode, and the control device controls, based on the voice instruction, to turn on the background wall downlight in the primary bedroom. In this manner, the user needs to name each lamp in the space in advance in the device management application, that is, each lamp corresponds to a unique voice instruction. Otherwise, the implementation cannot be implemented.

Compared with a conventional home system, the smart home system has more devices and functions, and quantities of devices and functions keep increasing. In addition, in an application scene of the smart home system, a current trend of a lighting system with the highest importance and the highest user interaction frequency is a “no-main-light design”. In an embodiment, in a single space, there is no main light as before. Instead, a plurality of lighting devices such as downlights and light strips are used to create a more even light environment, and the lighting devices are almost invisible in the physical space, to implement an effect of “seeing light but not seeing the lighting devices”. In other words, a same space may include a plurality of devices of a same type. In this application scene, regardless of whether the control device controls the single-product device in a touch or voice manner, operation costs or preparation costs of the user are high, affecting user experience.

### Example 2: Scene-Based Centralized Control of Devices Based on a User Operation

Scene-based centralized control means that the control device packages, based on a user requirement, a plurality of smart home devices into a “scene”, for example, a movie mode, a family mode, a relaxation mode, or a focus mode. The user only needs to trigger the scene. The control device may control the plurality of smart home devices of a same category or different categories in response to a control operation performed by the user on the triggered scene mode, without controlling single-product devices one by one. In different scene modes, the control device controls the smart home device to be in a preset on/off status or parameter status. For example, the user may create a “movie mode”. In this mode, a curtain is closed, a main light is turned off, and an ambient light is turned on to a dark mode.

In some embodiments, the control device may complete scene-based centralized control of the smart home devices on the touch interface based on a user operation. For example, FIG. 4B(a) to FIG. 4B(c) are a diagram of a process in which a control device controls a plurality of devices in a scene-based centralized control manner according to embodiments, and relates to a process in which the control device controls to “enable a movie mode” based on a user operation.

As shown in FIG. 4B(a) to FIG. 4B(c), after the user taps a “Scene” operation option shown in FIG. 4B(a), the control device displays, in response to the tap operation, an interface 405 shown in FIG. 4B(b). Operation options corresponding to different scene modes are displayed on the interface 405. The user taps an operation option of Movie mode on the interface 405, and the control device displays, in response to the tap operation of the user, an interface 406 shown in FIG. 4B(c). The interface 406 includes an on/off status or a parameter status of each smart home device in the movie mode, and “Edit more” and “Execute” operation options. For example, only three lights are turned on in lighting devices, a parameter of a cooling, heating, and fresh air device is adjusted to a temperature of 24° C. and humidity of 40%, a curtain is closed, and a speaker is started. After the user taps the “Execute” option on the interface 406, the control device controls each device in the movie mode in response to the tap operation.

In the control manner in Example 2, the control device can control a plurality of devices with one tap based on the user operation, but the user needs to define each scene in advance in the device management application. This also has a problem that preparation costs of the user are high. In addition, in a process of defining a scene, a device parameter and a startup status of each smart device in different scenes further need to be set. This also causes a problem of “difficulty in selecting a single-product device” and high user operation costs, affecting user experience.

In addition, “scene-based centralized control” is an integrated control process based on a fixed execution rule. When using smart home devices, the user is not always in a status corresponding to each scene, and often wants to fine-tune some parameters of some devices in life. In this scene, the same problems of “difficulty in selecting a single-product device” in device selection and high user operation costs also exist.

In conclusion, the foregoing plurality of different implementations all have a problem that operation costs or preparation costs of the user are high, and the user cannot intuitively and naturally select one or more devices that the user wants to control. In addition, due to more devices and more functions in the smart home system, when the user controls the smart home device in a conventional manner, user experience is poor.

Therefore, embodiments of this application provide a device control method, to resolve problems of difficult device selection and high user preparation costs in a smart home scene, so that the user can conveniently and quickly perform intelligent control on one or more devices in a target area range in an intuitive and natural manner. This simplifies an operation procedure, improves interaction efficiency of selecting a target device and controlling the target device in the smart home scene, and improves user experience.

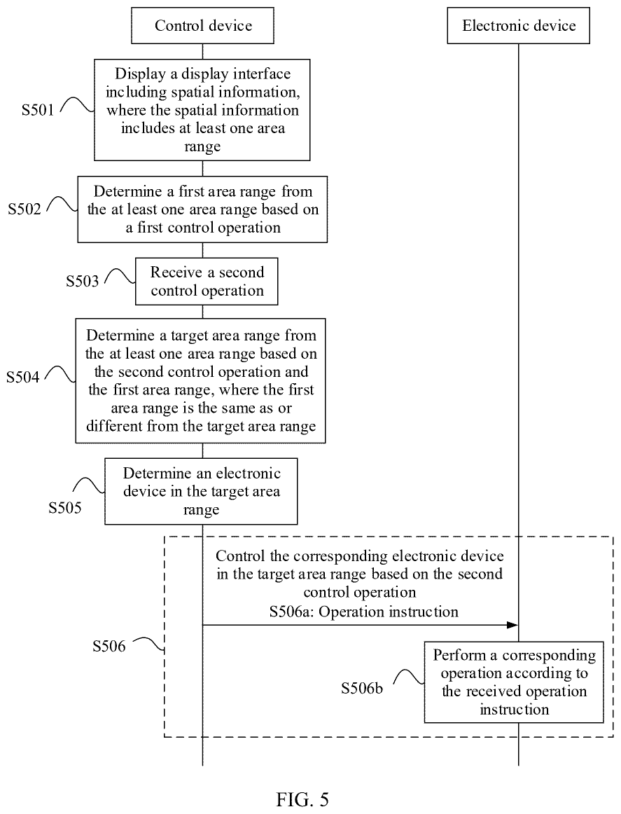

The following describes an example of a device control process provided in embodiments of this application with reference to FIG. 5 to FIG. 14B.

FIG. 5 is a schematic interaction flowchart of a device control method according to an embodiment of this application. As shown in FIG. 5, the method includes the following operations S501 to S506.

S501: A control device displays a display interface including spatial information, where the spatial information includes at least one area range.

In an embodiment, the display interface may be a running main interface of a device management application (for example, an AI Life application), or may be another interface, for example, a running interface displayed in response to a leftward or rightward swiping operation performed by a user on the main interface of the device management application, or a running interface displayed in an operation mode (for example, an area operation mode). For example, after the device management application is started and run, different operation modes, for example, a single-product device operation mode, a scene-based centralized control operation mode, and the area operation mode, are displayed on the main interface of the device management application. The different operation modes correspond to different operation manners of a smart home device. In an embodiment, the single-product device operation mode corresponds to the operation process of separately controlling the single-product device based on the user operation in Example 1, the scene-based centralized control operation mode corresponds to the operation process of performing scene-based centralized control on the devices based on the user operation in Example 2, and the area operation mode corresponds to an operation process of controlling the smart home device based on the user operation and the spatial information displayed on the display interface. After starting the device management application, the control device can display the display interface based on the user operation.

The spatial information is information that reflects a spatial distribution feature of a geographic entity. The spatial distribution feature includes a position of the entity, a shape of the entity, a spatial relationship between entities, an area spatial structure, and the like. For example, the spatial information may be a floor plan of a residential layout; a three-dimensional model diagram of a residential layout, a three-dimensional model diagram of soft furnishings layout information within a residential environment, or the like. For example, refer to the floor plan of the house structure of the home environment shown in (a) in FIG. 6, the three-dimensional model diagram of the house structure of the home environment shown in (b) in FIG. 6, and the three-dimensional model diagram of the soft furnishings layout information of the home environment shown in (c) in FIG. 6. The spatial information may alternatively be a topographic distribution diagram of an area of a city, or the like.

In some embodiments, the spatial information may be a floor plan, a three-dimensional model diagram, or the like stored in a host/server. A format of the floor plan may be an image format, for example, an exchangeable image file (EXIF) format, a portable network graphics (PNG) format, a joint photographic experts group (JPEG) format, or a web pape (weppy, webp) format. A format of the three-dimensional model diagram includes a motion capture tool (filmbox, FBX) format, a standard three-dimensional model (standard for the exchange of product model data, STEP) format, an object file (object, OBJ) format, or the like. The three-dimensional model diagram may be displayed on the display interface by using a 3D rendering engine.

In an embodiment, the spatial information may be obtained by using but not limited to the following methods and stored in the host/server.

(1) Floor plans of different types of houses in communities in different areas preset in a part of home decoration design software.

(2) A computer aided design (CAD) drawing or a floor plan of a house obtained through onsite surveying and mapping, where a three-dimensional model of the CAD drawing or the floor plan of the house may be automatically generated by using a tool, or may be manually generated by using three-dimensional design software.

(3) A three-dimensional model diagram that is of a house including soft furnishings and that is obtained by manually adding layout information of the soft furnishings to a three-dimensional model of the room.

(4) A three-dimensional model diagram of a house generated through onsite scanning by using a sensor with environment depth sensing, for example, a camera and/or a lidar.

Generally, the preset floor plan does not include the layout information of the soft furnishings. Therefore, all spatial information including the “floor plan” and the “soft furnishings” can be obtained at one time by using the foregoing method (3) or (4), and can be updated at any time.

In an embodiment, when the spatial information is the three-dimensional model or the floor plan of the home environment, the spatial information includes a layout of each spatial area in the home environment of the user and an orientation reference object of each room. The orientation reference object is a landmark entity indicating an area range in a spatial area. For example, refer to the floor plan of the house structure shown in (a) in FIG. 6. The spatial information includes several spatial areas such as a primary bedroom, a secondary bedroom, a living room, a dining room, a kitchen, and a bathroom. Each spatial area includes various orientation reference objects, for example, a sofa, a coffee table, a living room door, and the like in the living room, a primary bedroom bed, a dressing table, a desk, and the like in the primary bedroom or the secondary bedroom, and a washstand, a toilet, and the like in the bathroom. The sofa indicates an area range that includes a position of the sofa in the living room, and the primary bedroom bed indicates an area range that includes a position of the primary bedroom bed in the primary bedroom.

It should be noted that the area range in an embodiment may be an area range including all spatial information, for example, an area range of all spatial areas included in the floor plan of the house structure of the home environment; or may be an area range corresponding to different spatial areas in the spatial information, for example, an area range included in the primary bedroom in the floor plan of the house structure, or an area range included in the living room; or may be an area range corresponding to an orientation reference object in each spatial area, for example, an area range corresponding to the position of the sofa in the living room, or an area range corresponding to the position of the primary bedroom bed in the primary bedroom.

In an embodiment, the area range may include but is not limited to the following forms.

### (1) Dot Area Range

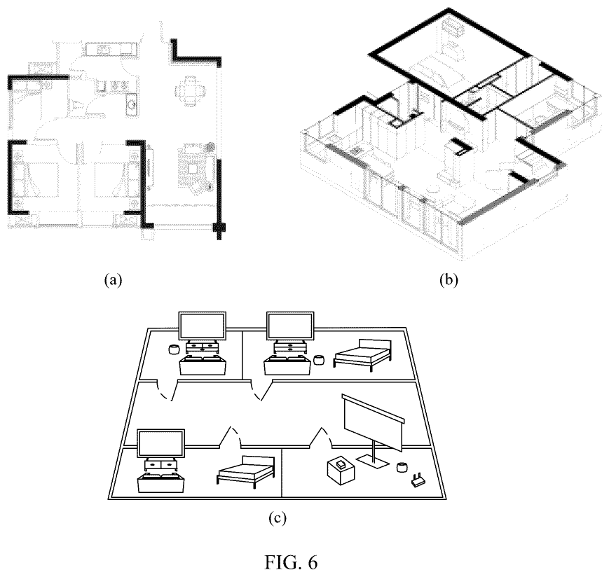

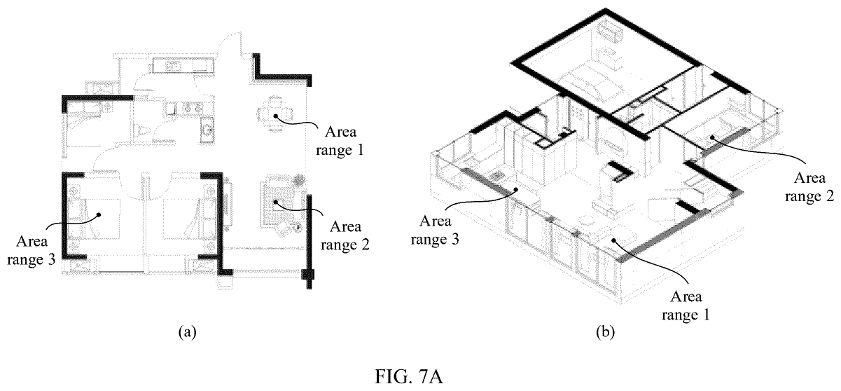

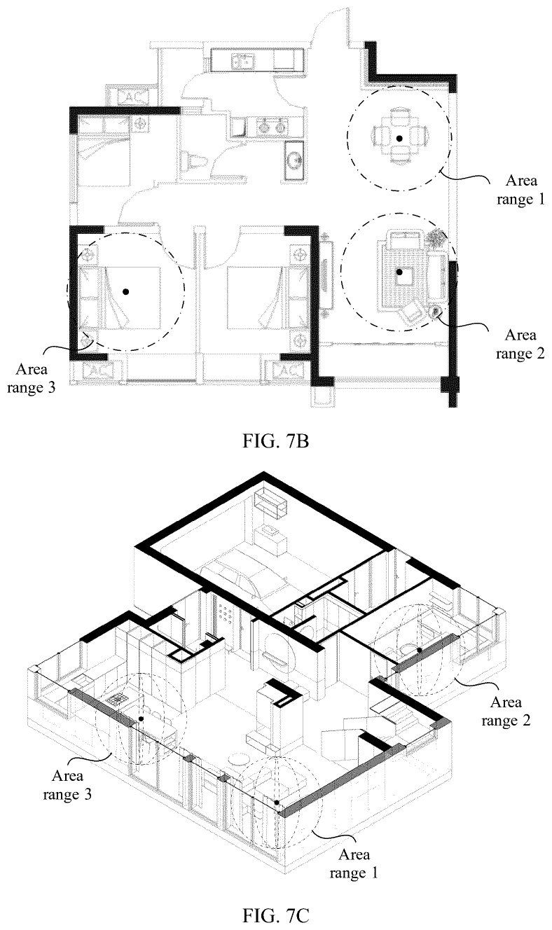

For example, the area range may be any point in the spatial information. As shown in (a) and (b) in FIG. 7A, the area range includes a dot area range 1 corresponding to a dining room, a dot area range 2 corresponding to a living room, and a dot area range 3 corresponding to a primary bedroom in (a), and a dot area range 1 corresponding to a living room, a dot area range 2 corresponding to a bathroom, and a dot area range 3 corresponding to a dining room in (b).

### (2) Two-Dimensional Area Range

For example, when the spatial information is the floor plan of the house structure, the area range may be a preset plane range around any point in the spatial information. The point may be a center point of the preset plane range, for example, a center of a circular area range; or may be any point in the preset plane range, for example, a vertex of a rectangular area range. As shown in FIG. 7B, the spatial information shown in the figure includes a plane area range 1 corresponding to a dining room, a plane area range 2 corresponding to a living room, and a plane area range 3 corresponding to a primary bedroom. The plane area range may be a circular area range shown in FIG. 7A, or may be another shape, for example, a triangle, a rectangle, an ellipse, a polygon, or another irregular shape.

### (3) Three-Dimensional Area Range

For example, when the spatial information is the three-dimensional diagram of the house structure, the area range may be a preset spatial range around any point in the spatial information. The point may be a center point of the preset spatial range, for example, a center of a sphere; or may be any other point in the preset spatial range, for example, a vertex of a cone. As shown in FIG. 7C, the spatial information shown in the figure includes a spatial area range 1 corresponding to a living room, a spatial area range 2 corresponding to a bathroom, and a spatial area range 3 corresponding to a dining room. The area range may be a spherical spatial area shown in FIG. 7B, or may be a cubic spatial area, a cuboid spatial area, or the like.

It should be understood that the spatial information shown in FIG. 7A, FIG. 7B, and FIG. 7C may further include more or fewer area ranges, or larger or smaller area ranges. A smart home device corresponding to each area range is disposed in the area range. Positions and a quantity of area ranges may be set by an operation and maintenance engineer in the background based on an actual requirement, and are not listed one by one in an embodiment.

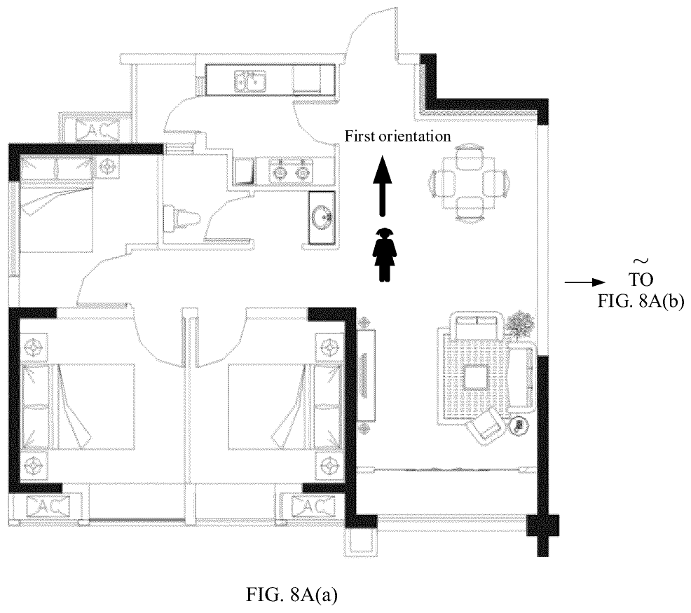

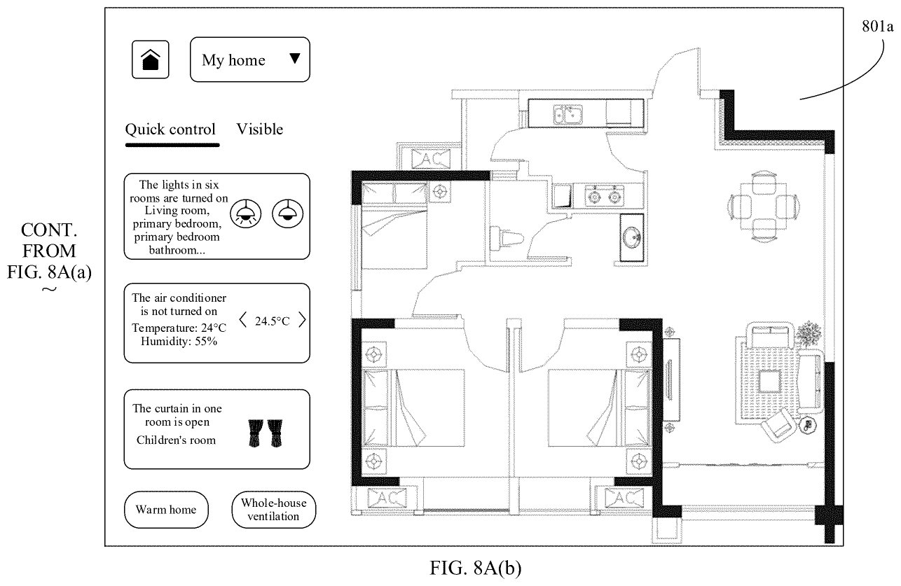

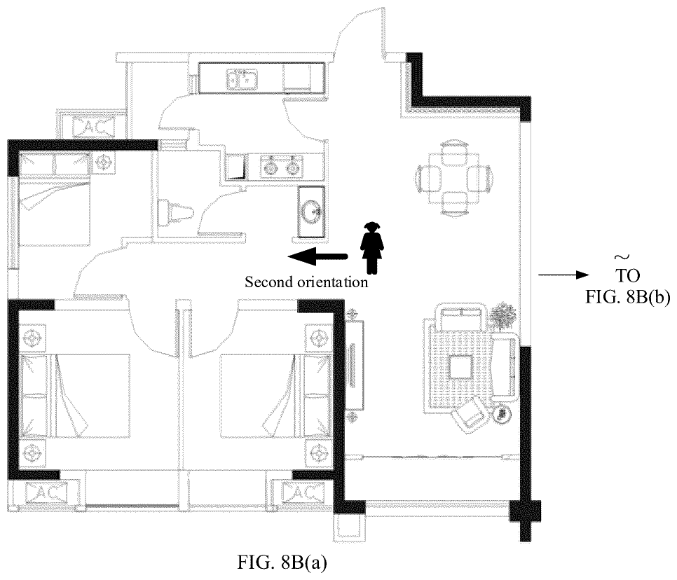

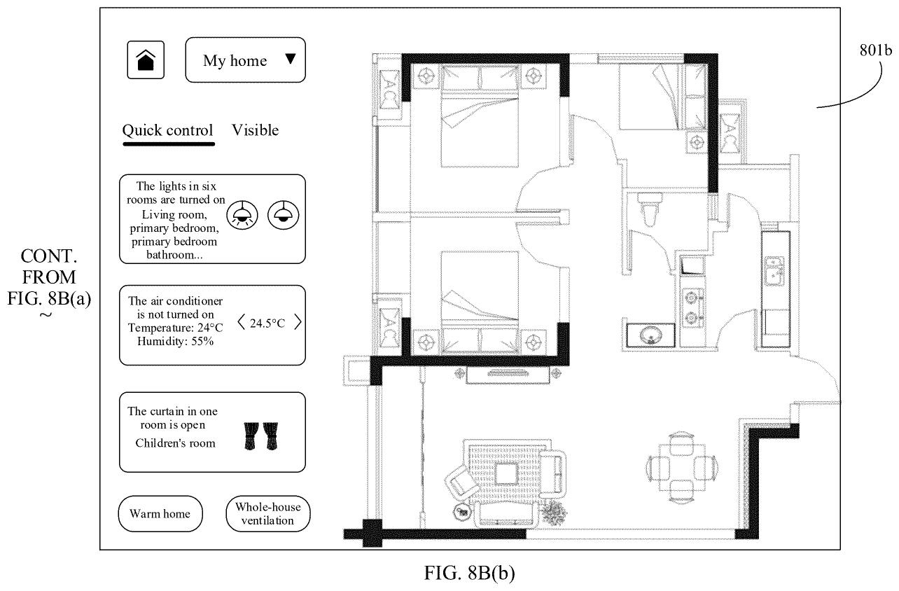

In some embodiments, when displaying the display interface including the spatial information, the control device first determines a position orientation of the control device in a physical space; and then controls a display direction of the spatial information in a first direction of the control device to be consistent with the position orientation of the control device. The display direction in the first direction of the control device may be a display direction in which the control device faces upward. When the position orientation of the control device in the physical space changes, the display direction of the spatial information on the display interface of the control device is adjusted based on a changed position orientation. For example, as shown in FIG. 8A(a) and FIG. 8A(b), when an orientation of the user holding the control device in the physical space is a first orientation (namely, the position orientation) shown in FIG. 8A(a), the control device displays a display interface 801a of the spatial information shown in FIG. 8A(b). On the display interface 801a, the display direction in which the control device faces upward (also referred to as the first direction) is consistent with the first orientation of the user in the physical space. As shown in FIG. 8B(a) and FIG. 8B(b), when the orientation of the user holding the control device in the physical space is a second orientation shown in FIG. 8B(a), the control device displays a display interface 801b of the spatial information shown in FIG. 8B(b). On the display interface 801b, the display direction in which the control device faces upward is consistent with the second orientation of the user in the physical space. When the orientation of the user holding the control device in the physical space continuously changes, the display direction of the spatial information on the display interface of the control device is adaptively adjusted based on the orientation of the user in the physical space. In other words, “left-up-right-down” in the spatial information respectively correspond to “left-front-right-rear” relative to the user in the real physical space. This complies with a map viewing habit of the user.

It should be noted that, in an embodiment, the display direction in which the control device faces upward may be defined in the following manners:

(1) If the control device is vertically placed (or an included angle between the control device and a horizontal plane is greater than 0°), “upward” is a direction from a bottom of the control device to a top of the control device.

(2) If the control device is horizontally placed, the “upward” direction inherits an upward direction before the control device is horizontally placed (when the control device is vertically placed). Alternatively, the upward direction of the interface may be adjusted based on a person's orientation (determined based on a face orientation) obtained by a sensor like a front-facing camera.

In this manner, the user can more intuitively map the spatial information on the display interface, for example, the three-dimensional model diagram of the house structure of the home environment or the floor plan of the house structure of the home environment, to the real physical space, and the view display direction of the spatial information can be adaptively adjusted based on the position orientation of the control device in the physical space, to improve user experience.

In some embodiments, an orientation of the control device relative to an indoor environment is obtained in the following manners:

(1) The control device is fixedly placed at a position in the indoor environment, and the orientation information may be pre-stored in a storage module of the control device.

(2) The control device is provided with a magnetic base accessory, the magnetic base is fastened to a wall, and the magnetic base encodes orientation information through near field communication (near field communication, NFC). After the control device contacts the magnetic base, the orientation information can be obtained through NFC.

(3) North-south orientations of the indoor environment are preconfigured in the control device, and an orientation of a control terminal in an earth coordinate system is obtained by a sensor like a built-in magnetometer of the control device, so that an orientation of the control device relative to the indoor environment can be calculated.

S502: The control device determines a first area range from the at least one area range based on a first control operation.

The first control operation includes a touch operation like tapping, touching and holding, double tapping, or swiping.

In an embodiment, that the control device determines the first area range from the at least one area range based on the first control operation includes: The control device determines, based on projection coordinates of the first control operation in an area range in the spatial information in response to the first control operation performed by the user on the spatial information, the first area range from the at least one area range included in the spatial information. For example, when the user taps any position on the display interface of the control device, the control device projects the tapped position onto a plane or a three-dimensional diagram of the spatial information, to obtain projection coordinates of the tapped position on the plane or the three-dimensional diagram, and then determines the first area range based on an area range indicated by the projection coordinates. In an embodiment, when the projection coordinates have no corresponding area range, an area range adjacent to the projection coordinates is determined as the first area range.

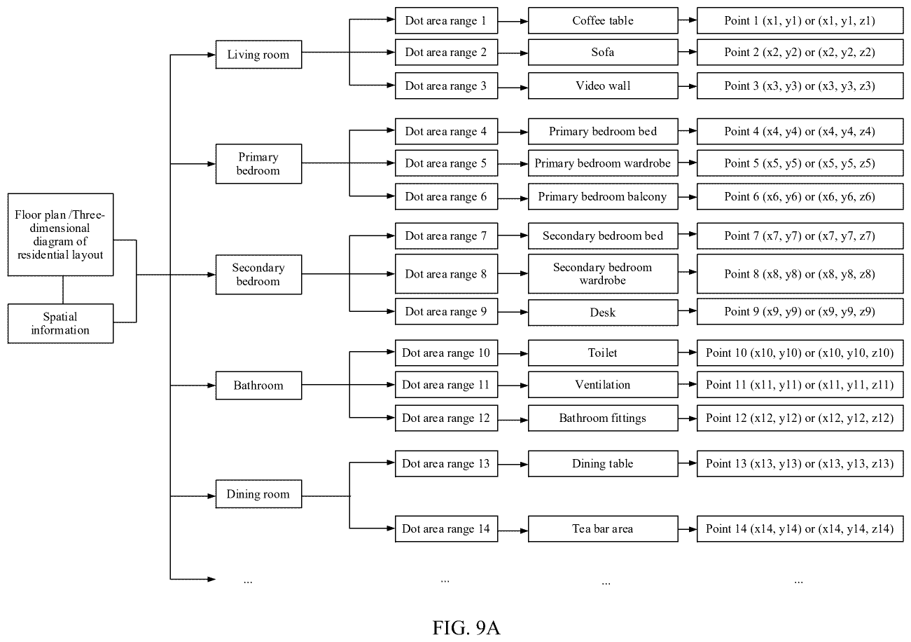

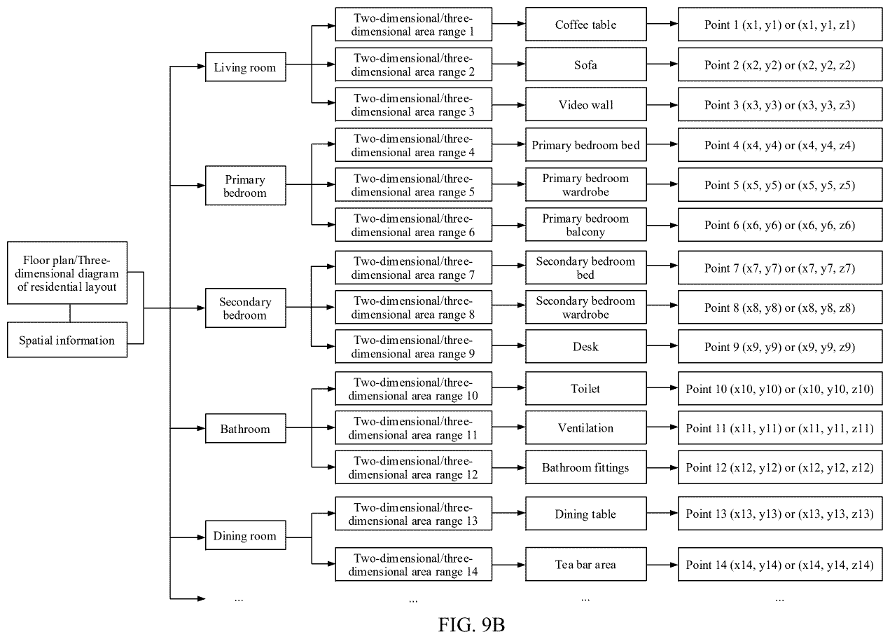

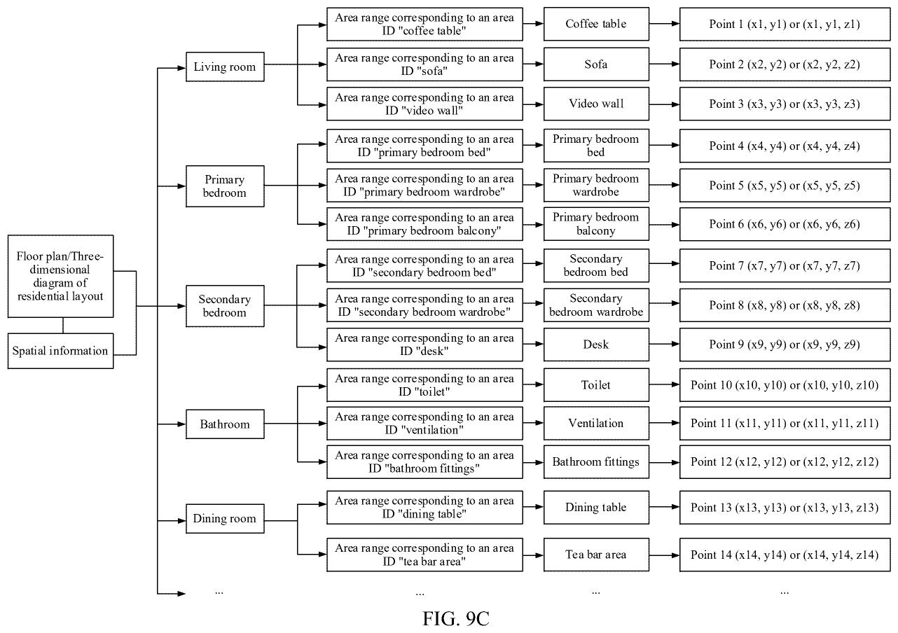

In some embodiments, the area range includes a dot area range corresponding to the projection coordinates at which the first control operation is projected onto the spatial information. The area range may be planar coordinates (xₙ, yₙ) or spatial coordinates (xₙ, yₙ, zₙ). For example, as shown in FIG. 9A, projection coordinates of each point in the spatial information correspond to a dot area range. For example, projection coordinates (x₁, y₁) or (x₁, y₁, z₁) of a point 1 fall at a position of a coffee table in a living room in the spatial information, a corresponding area range is a dot area range 1, and the dot area range 1 may include electronic devices such as a coffee table ceiling lamp; projection coordinates (x₂, y₂) or (x₂, y₂, z₂) of a point 2 fall at a position of a sofa in the living room in the spatial information, a corresponding area range is a dot area range 2, and the dot area range 2 may include electronic devices such as a sofa wall lamp; and the rest may be deduced by analogy.

In some other embodiments, the area range includes a two-dimensional area range or a three-dimensional area range corresponding to the projection coordinates at which the first control operation is projected onto the spatial information. For example, when the projection coordinates at which the first control operation is projected onto the spatial information are (x₁, y₁), an indicated area range is a circular plane area range whose geometric center is the projection coordinates (x₁, y₁) and whose radius is r, or a rectangular spatial area range (namely, a three-dimensional area range) whose geometric center is the projection coordinates (x₁, y₁, z₁) and whose length, width, and height are respectively l, w, and h. For example, as shown in FIG. 9B, projection coordinates of each point in the spatial information correspond to a two-dimensional or three-dimensional area range. For example, projection coordinates (x₄, y₄) or (x₄, y₄, z₄) of a point 4 falls at a position of a primary bedroom bed in the spatial information, a corresponding area range is a two-dimensional/three-dimensional area range 4 whose geometric center is the projection coordinates (x₄, y₄) or (x₄, y₄, z₄), and the two-dimensional/three-dimensional area range 4 may include electronic devices such as a primary bedroom bedside lamp; projection coordinates (x₅, y₅) or (x₅, y₅, z₅) of a point 5 falls at a position of a primary bedroom wardrobe in the spatial information, a corresponding area range is a two-dimensional/three-dimensional area range 5 whose geometric center is the projection coordinates (x₅, y₅) or (x₅, y₅, z₅), and the two-dimensional/three-dimensional area range 5 may include electronic devices such as a smart wardrobe; and the rest may be deduced by analogy.

In still some other embodiments, the area range includes area identification information (Identity, ID) corresponding to the projection coordinates at which the first control operation is projected onto the spatial information, and is referred to as an area range indicated by an area ID for short. Each area range corresponds to an area ID of the area range. The area ID may be a name of a spatial area, for example, “bedroom”, “living room”, “movie watching area”, or “leisure area”; or may be a name of an orientation reference object, for example, “living room sofa”, “coffee table”, or “primary bedroom bed”. For example, an area range indicated by an area ID “living room sofa” is a preset area range corresponding to “living room sofa”; and an area range indicated by an area ID “bedroom” is a preset area range corresponding to “bedroom”. For example, as shown in FIG. 9C, projection coordinates of each point in the spatial information correspond to an area range indicated by an area ID. For example, projection coordinates (x₉, y₉) or (x₉, y₉, z₉) of a point 9 fall at a position of a desk in a secondary bedroom in the spatial information, a corresponding area range is an area range corresponding to an area ID “desk”, and the area range corresponding to the area ID “desk” may include electronic devices such as a desk lamp; projection coordinates (x₁₄, y₁₄) or (x₁₄, y₁₄, z₁₄) of a point 14 fall at a position of a tea bar area in a dining room in the spatial information, a corresponding area range is an area range corresponding to an area ID “tea bar area”, and the area range corresponding to the area ID “tea bar area” may include electronic devices such as a tea bar machine; and the rest may be deduced by analogy.

It should be noted that each area range may include one or more electronic devices. For example, the area range corresponding to the area ID “tea bar area” may include the tea bar machine, or may include other electronic devices such as a tea bar machine ceiling lamp and a water dispenser. Settings may be performed during configuration, and are not listed one by one in an embodiment.

For example, a process in which the control device determines the first area range is described by using an example in which the corresponding area range indicated by the projection coordinates is the area range indicated by the area identification information of the projection coordinates.

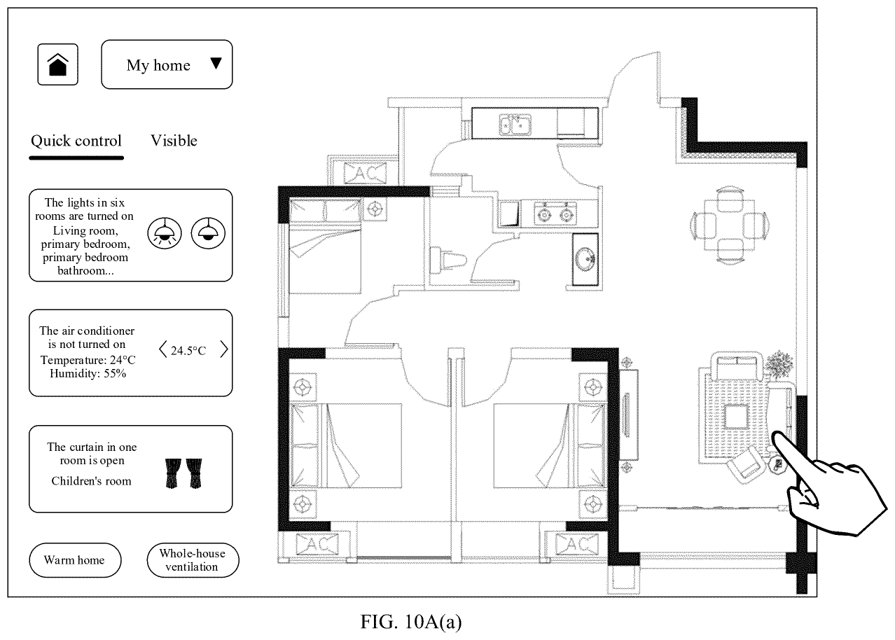

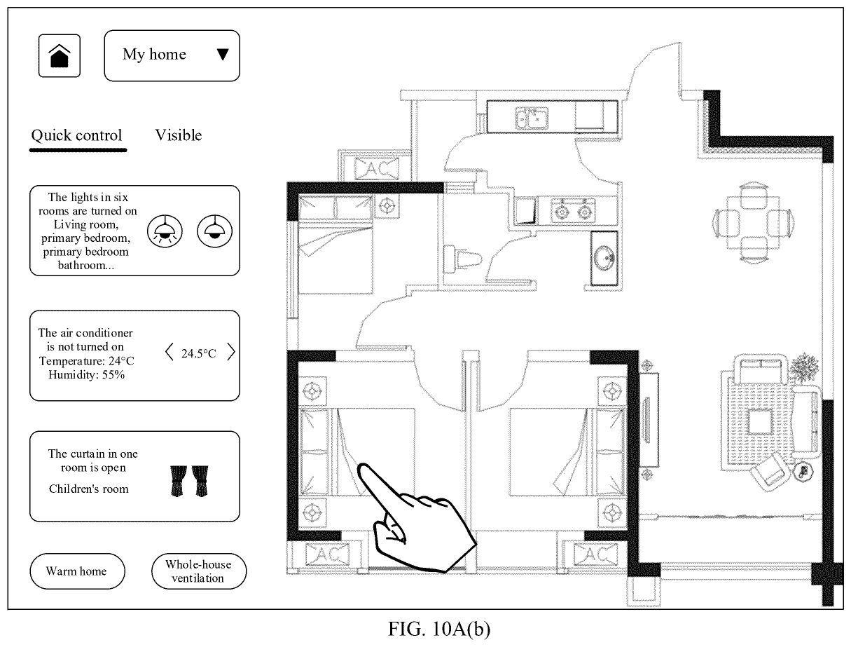

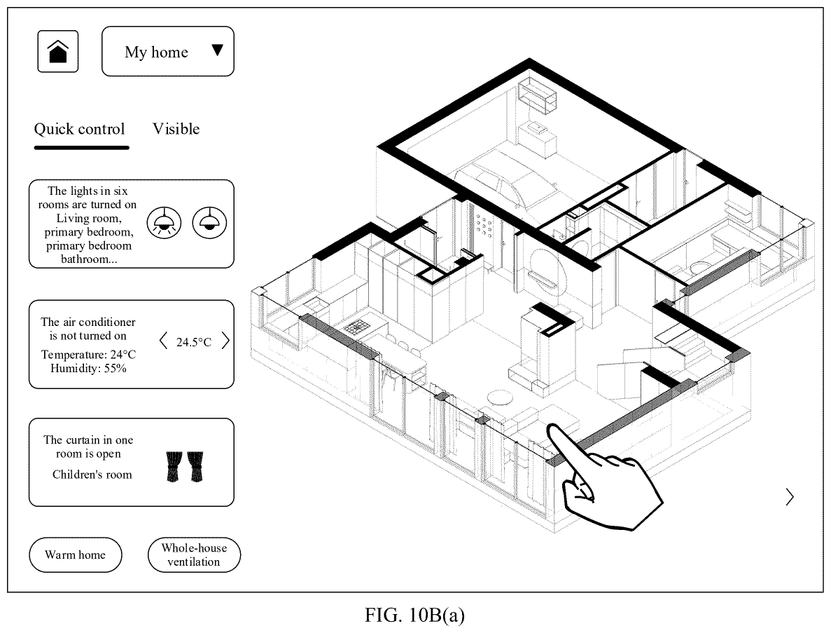

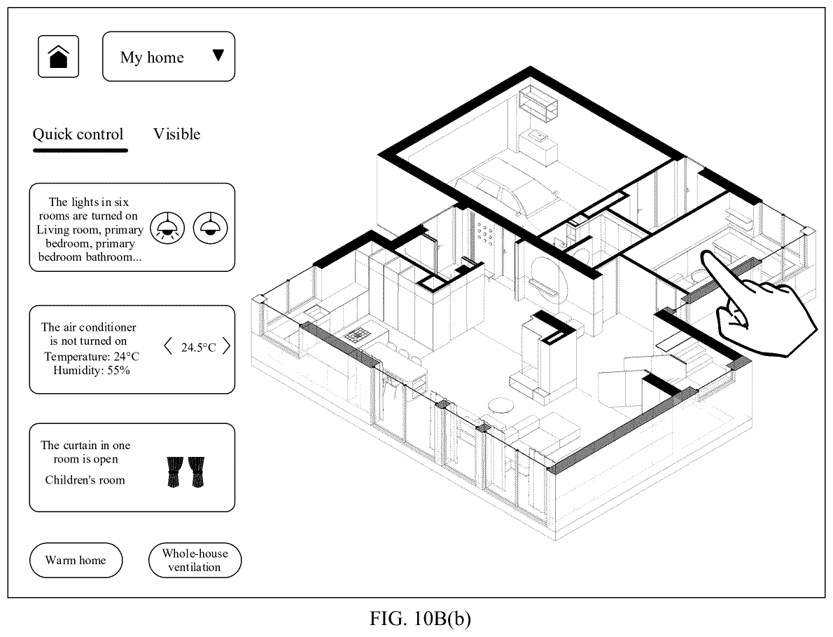

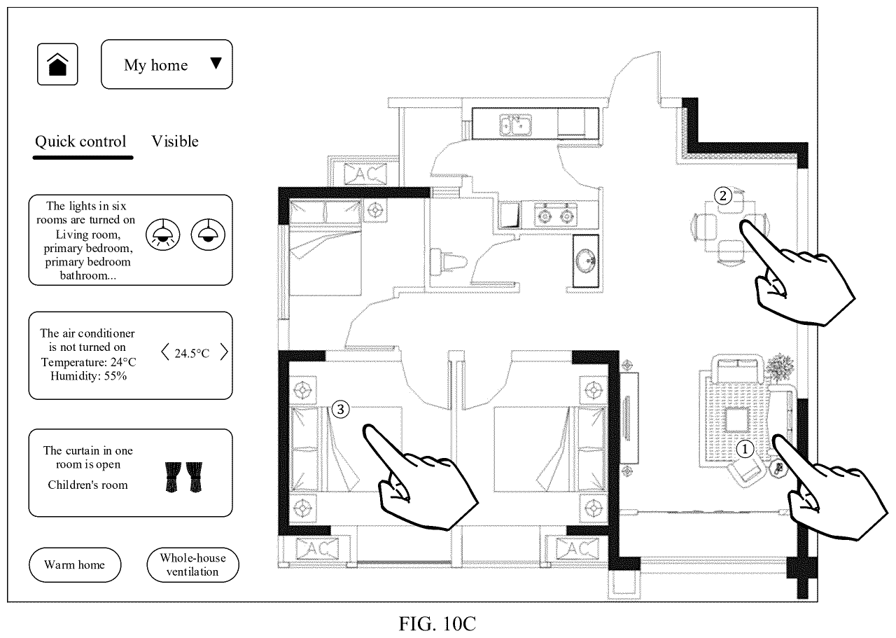

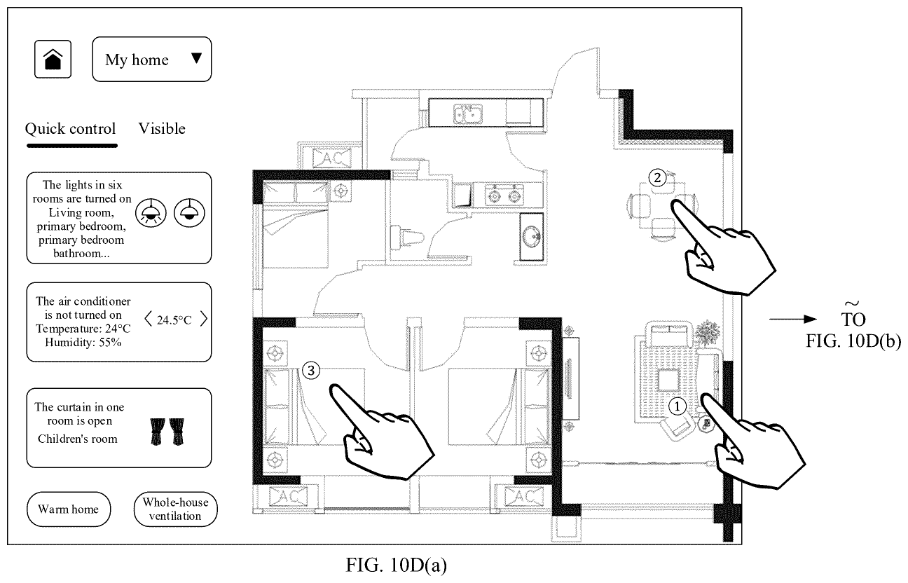

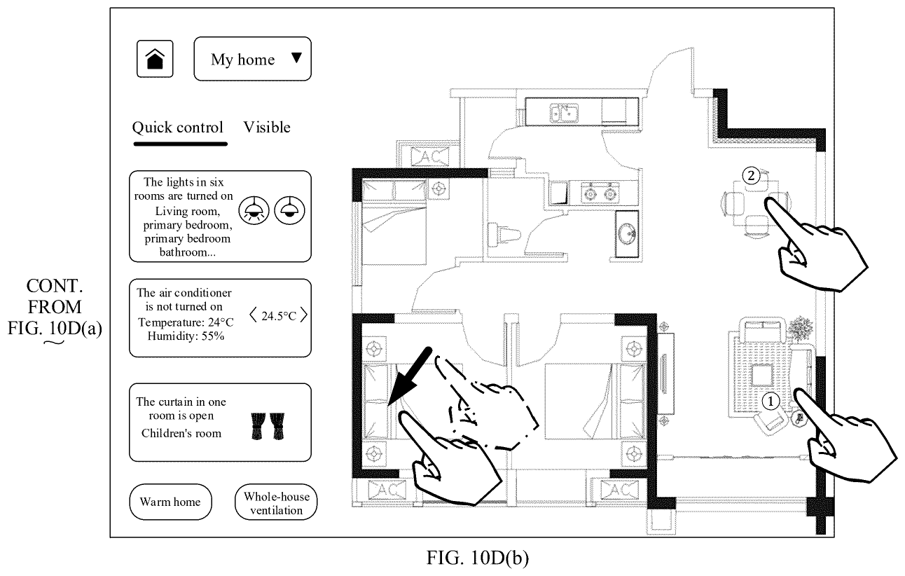

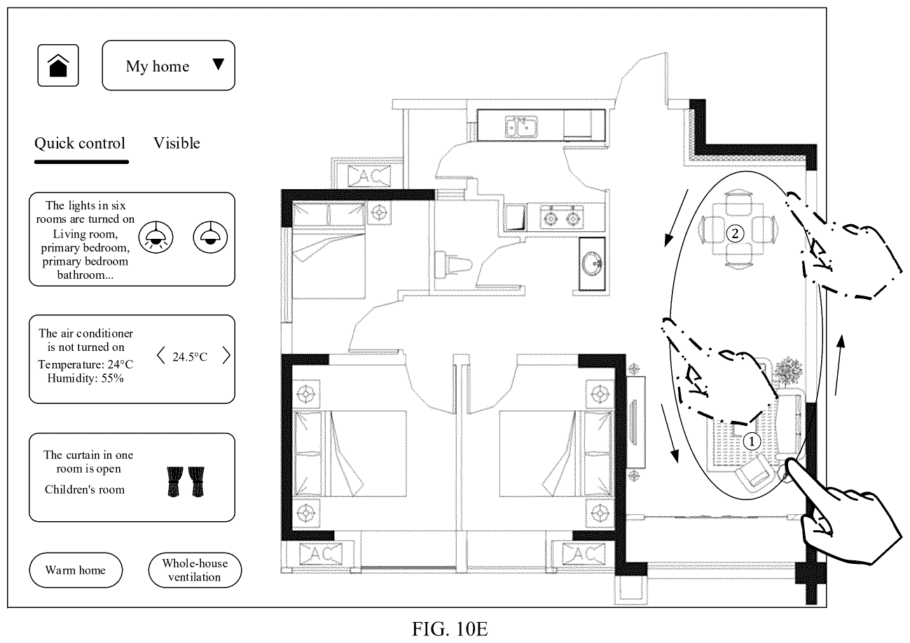

As shown in FIG. 10A(a) and FIG. 10A(b), when the user taps a tap position shown in FIG. 10A(a), the control device projects the tap position of the user onto a floor plan of a house structure, to obtain that projection coordinates corresponding to the tap position of the user in the floor plan of the house structure fall within a plane area range corresponding to a “living room sofa”, and then determines, based on that an area range indicated by the projection coordinates includes a plane area range indicated by area identification information, the plane area range corresponding to the “living room sofa” as the first area range. When the user taps a tap position shown in FIG. 10A(b), the control device projects the tap position of the user onto a floor plan of a house structure, to obtain that projection coordinates corresponding to the tap position of the user in the floor plan of the house structure fall within a plane area range corresponding to a “primary bedroom bed”, and then determines, based on that an area range indicated by the projection coordinates includes the plane area range indicated by the area identification information, the area range corresponding to the “primary bedroom bed” as the first area range. It may be understood that, when the spatial information is a three-dimensional diagram of a house structure, as shown in FIG. 10B(a), when the user taps a position of area identification information of a sofa in the three-dimensional diagram of the house structure, the control device determines, in the foregoing determining process, a spatial area range corresponding to the sofa as the first area range; and as shown in FIG. 10B(b), when the user taps a position of area identification information of a primary bedroom bed in the three-dimensional diagram of the house structure, the control device determines, in the foregoing determining process, a spatial area range corresponding to the primary bedroom bed as the first area range.

It should be noted that there may be one or more first area ranges, which may be determined based on a user operation.

In some embodiments, the control device receives a selection operation performed by the user on N area ranges in the spatial information. For example, the user may select the N area ranges in the spatial information through “a plurality of taps”. The control device receives a cancellation operation performed by the user on M of the N area ranges. For example, the user may cancel selection of the M of the N area ranges by “swiping”. In this case, the control device determines N-M area ranges as the first area range, where N≥M≥1. For example, as shown in FIG. 10C, the user selects an area range \textcircled{1}, an area range \textcircled{2}, and an area range \textcircled{3} through “a plurality of taps”, and the control device determines the area range \textcircled{1}, the area range \textcircled{2}, and the area range \textcircled{3} as the first area range. As shown in FIG. 10D(a) and FIG. 10D(b), the user swipes out the area range \textcircled{3}, and the control device determines remaining area ranges other than the swiped-out area range as the first area range, that is, the control device determines the area range \textcircled{1} and the area range \textcircled{2} as the first area range.

In some other embodiments, the control device receives a tap operation performed by the user on the N area ranges in the spatial information, and determines the N area ranges as the first area range. For example, as shown in FIG. 10C, the user selects the area range \textcircled{1}, the area range \textcircled{2}, and the area range \textcircled{3} through “a plurality of taps”, and the control device directly determines the area range \textcircled{1}, the area range \textcircled{2}, and the area range \textcircled{3} as the first area range. Alternatively, the control device receives a swiping selection operation performed by the user on a first area in the spatial information, and determines N area ranges included in the first area as the first area range, where N≥1. For example, as shown in FIG. 10E, the user draws an elliptical first area shown in FIG. 10E by using a swiping selection operation. The elliptical first area includes the area range \textcircled{1} and the area range \textcircled{2}. The control device determines the area range \textcircled{1} and the area range \textcircled{2} as the first area range.

In some embodiments, after determining the first area range in response to the first control operation performed by the user on the spatial information, the control device extracts a candidate control instruction related to the first area range, and displays an element control of the candidate control instruction on the display interface. The element control indicates the user to input the control instruction based on content corresponding to the element control.

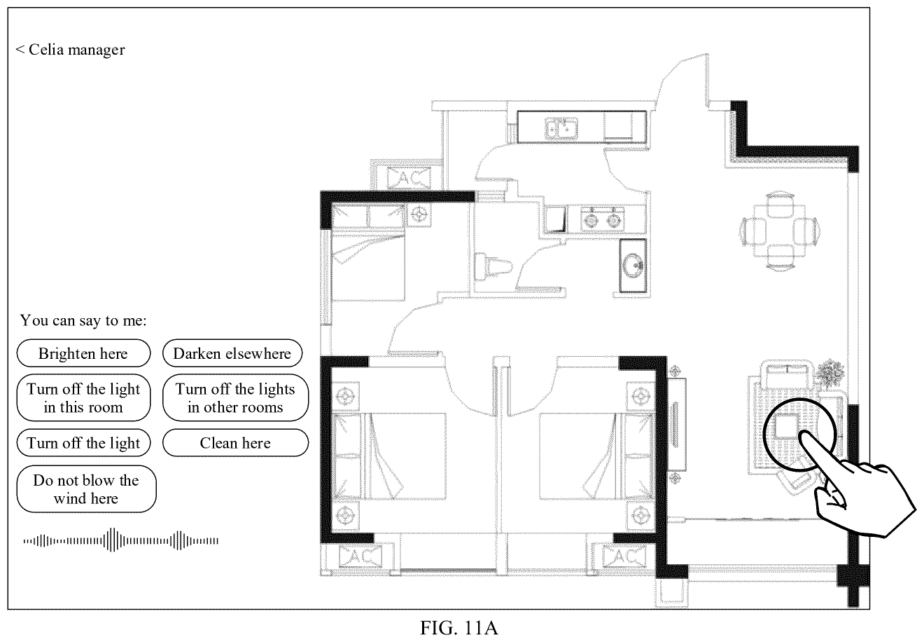

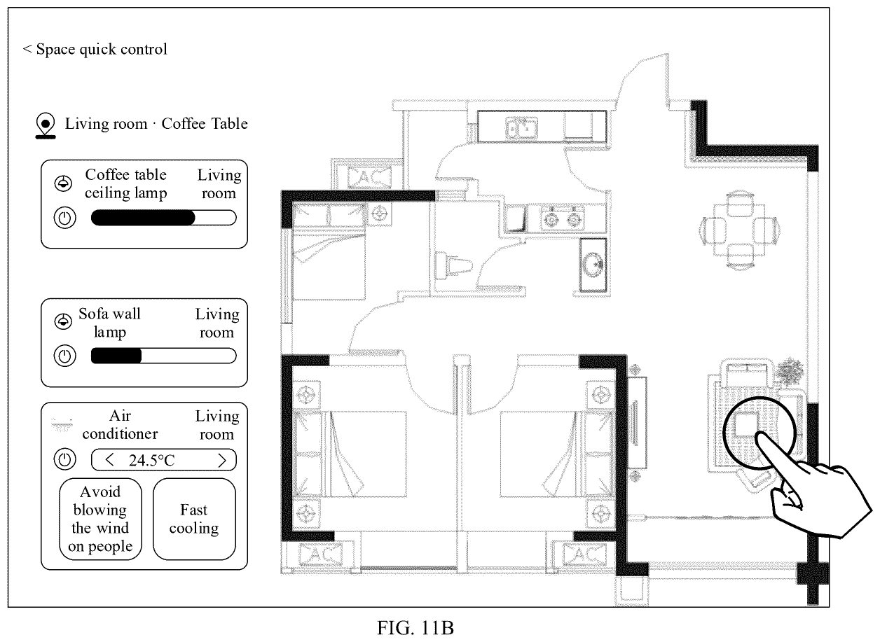

In an embodiment, as shown in FIG. 11A, the user taps the “living room sofa”, and element controls of devices near the “living room sofa”, for example, Brighten here, Darken elsewhere, and Turn off the light in this room, are displayed on the control interface. The user may trigger corresponding control by tapping an operation option corresponding to the element control or saying corresponding words in the element control.

In an embodiment, as shown in FIG. 11B, the user taps the “living room sofa”, and element controls of devices near the “living room sofa”, for example, a switch and a brightness adjustment control of a coffee table ceiling lamp, a switch and a brightness adjustment control of a sofa wall lamp, and a switch and a temperature adjustment control of an air conditioner, are displayed on the control interface. The user may trigger corresponding control by tapping an element control corresponding to each device or adjusting an element control of a slider.

S503: The control device receives a second control operation.

The second control operation includes a voice control operation (for example, a voice input), a touch control operation (for example, a touch input), or the like. That the control device receives the second control operation includes: The control device receives a control instruction input by the user via voice or touch.

It should be noted that, when the user expresses, to the control device via voice input or touch input, a type of an electronic device that the user wants to control, the control instruction included in the second control operation may include orientation reference information, or may not include orientation reference information. In this case, after receiving the second control operation, the control device needs to analyze the control instruction in the second control operation, to determine whether the control instruction includes the orientation reference information. In an embodiment, the second control operation may be a voice or touch operation performed by the user on an operation option or a control widget on the control interface shown in FIG. 10A(a) and FIG. 10A(b) or FIG. 10B(a) and FIG. 10B(b).

The orientation reference information is related content that describes orientation information, and includes but is not limited to “here”, “this room”, “elsewhere”, “other rooms”, “around”, “next to”, “nearby”, and the like.

In an embodiment, the control instruction input by the user via voice includes but is not limited to the following: “Brighten here”, “Darken elsewhere”, “Turn off the light in this room”, “Turn off the lights in other rooms”, “Turn on the light”, “Clean here”, “Do not blow the wind here”, and the like.

The control instruction input by the user through touch includes but is not limited to: “Turn on/off the light”, “Increase/Decrease the brightness”, “Clean the area”, “Adjust the wind direction”, and the like.

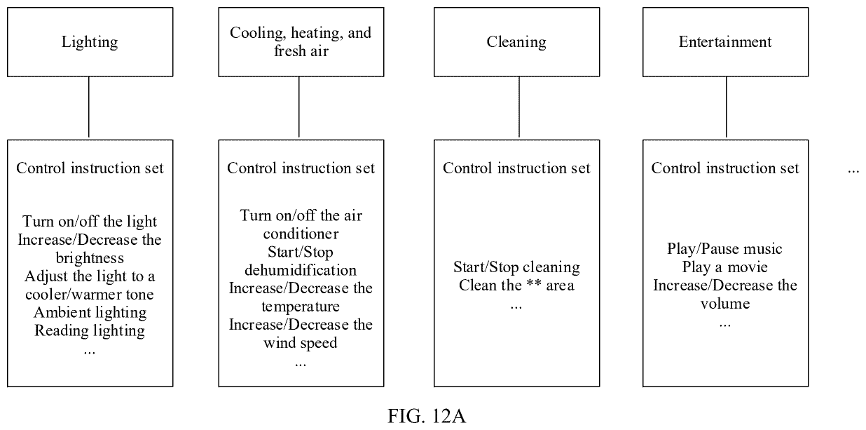

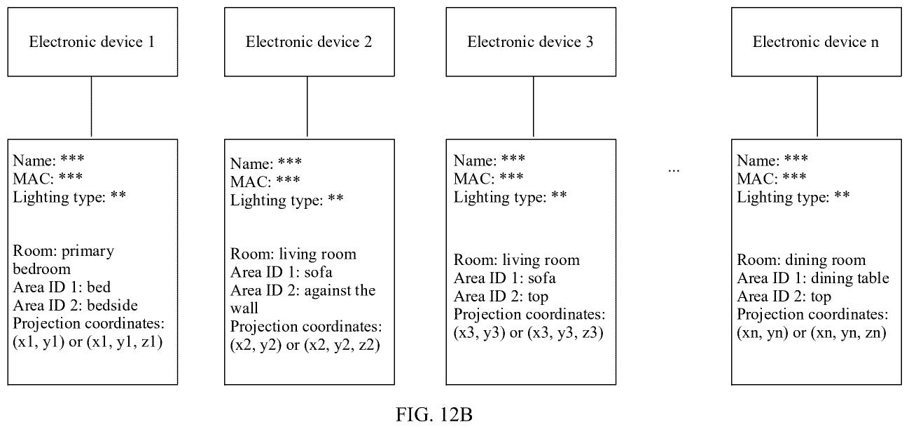

In an embodiment, different control instructions correspond to different types of electronic devices, or different types of electronic devices correspond to respective control instruction sets. As shown in FIG. 12A, for example, “Turn on/off the light” corresponds to “a lighting device”, “Clean the area” corresponds to “a robotic vacuum cleaner”, and “Adjust the wind direction” corresponds to “an air conditioner/fan”. In addition, when each electronic device performs adaptive configuration with the spatial information, the electronic device also associates different types of electronic devices or different electronic devices of a same type with an area range in the spatial information. For example, as shown in FIG. 12B, the spatial information includes a field used to describe an area range in which the electronic device is located, a spatial area (for example, a living room, a primary bedroom, or a dining room) in which the electronic device is located, an area ID (for example, an area ID “sofa” or an area ID “coffee table”), corresponding projection coordinates (for example, (x₁, y₁) or (x₁, y₁, z₁), or (x₂, y₂) or (x₂, y₂, z₂)), and the like. Different electronic devices may have one or more area IDs because of different positions of the electronic devices. For example, a spotlight located on a sofa background wall may have an area ID “sofa” and an additional area ID “against the wall” to describe a position of the spotlight. Different electronic devices may have different quantities of area IDs.

It can be learned from the foregoing that, the control instruction input by the user via voice or touch may be a control instruction including a type of an electronic device that needs to be controlled and an action that needs to be performed on the electronic device, for example, Turn on a light, Turn off a light, or Turn off a computer, where turn on and turn off are actions that need to be performed, and the light and the computer are electronic devices that need to be controlled; or may be a control instruction including a type of an electronic device that needs to be controlled, an action that needs to be performed on the electronic device, and orientation reference information, for example, Brighten here, Darken elsewhere, or Clean here, where brighten, darken, and clean respectively correspond to electronic devices: the light, the light, and the robotic vacuum cleaner, corresponding actions are brighten, darken, and clean, and here, elsewhere, and here respectively correspond to the orientation reference information. Therefore, after receiving different types of control instructions, the control device needs to analyze the control instructions, and then determine an operation that needs to be performed based on an analysis result.

In some embodiments, the control device extracts, by using a natural language processing (NLP) technology or based on a large language model (LLM), semantic information from the control instruction input by the user via voice or touch. When extracted voice information includes any one of the foregoing orientation reference information, it is determined that the control instruction includes orientation reference information. For example, if the control instruction of the second control operation input by the user is “Turn off the lights in other rooms”, and the control device determines, by using the NLP technology, that the control instruction includes voice information “other rooms”, it is determined that the control instruction of the second control operation includes orientation reference information.

S504: The control device determines a target area range from the at least one area range based on the second control operation and the first area range, where the first area range is the same as or different from the target area range.

In operation S502, the control device has determined the first area range from the at least one area range in response to the first control operation performed by the user on the spatial information. In this operation, the control device determines, based on the determined first area range and the second control operation, the target area range that needs to be controlled. The first area range may be the same as or different from the target area range. In other words, the control device needs to further determine, by using the second control operation, whether the target area range that the user wants to control is the first area range indicated by the first control operation, or another area range different from or associated with the first area range. The control instruction of the second control operation includes the type of the electronic device that needs to be controlled and the action that needs to be performed on the electronic device. Therefore, after determining the target area range, the control device determines the electronic device that needs to be controlled in the target area range.

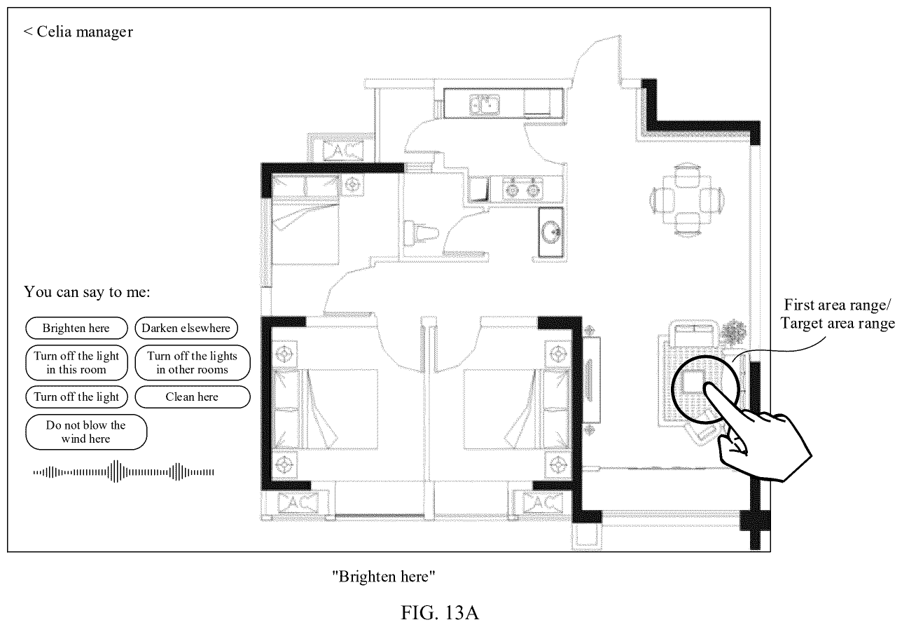

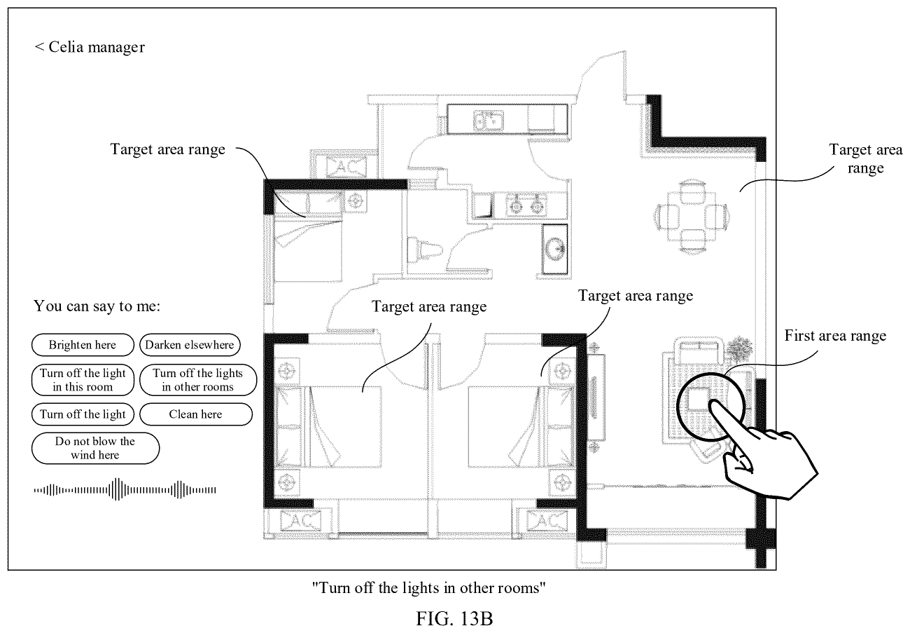

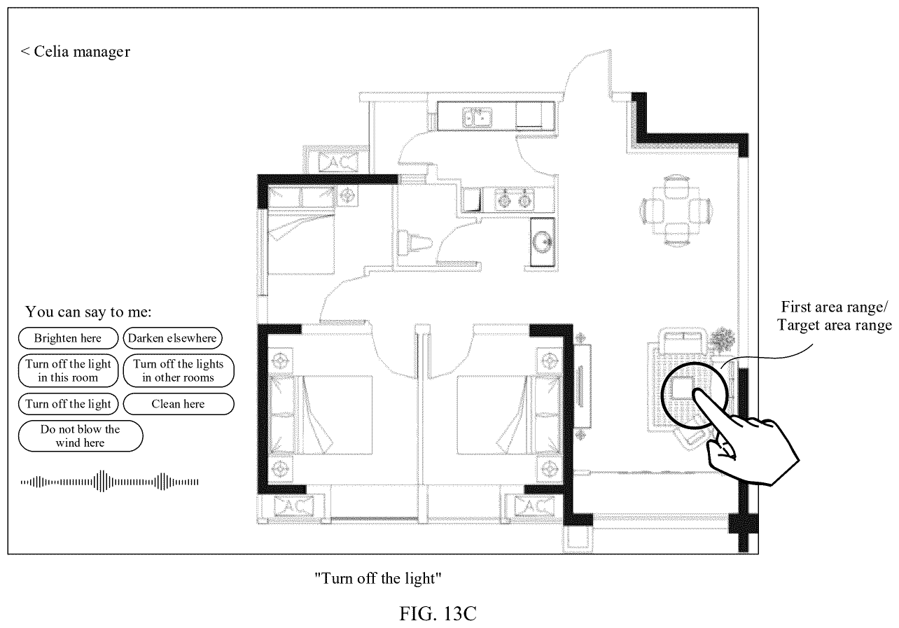

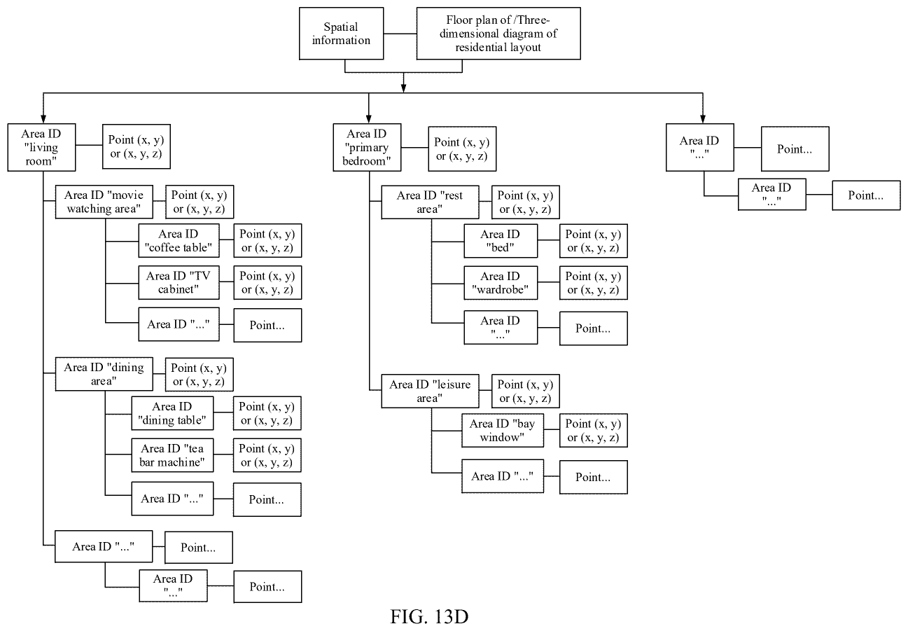

In an embodiment, as shown in FIG. 13A, the control device has determined, in response to the first control operation of the user, the area range corresponding to the area ID “living room sofa” as the first area range; and then extracts semantic information in the second control operation after receiving the second control operation “Brighten here” input by the user via voice. After analyzing the semantic information, the control device determines that the semantic information includes an orientation reference word “here”, and then determines the target area range as the first area range, namely, the area range corresponding to the area ID “living room sofa”, based on the orientation reference word “here”. In this case, the first area range is the same as the target area range.

In this example, if the control device receives a second control operation “turn on the light in this room” that is input by the user via voice, the control device extracts semantic information in the second control operation, and determines, after analysis, that the voice information includes an orientation reference word “this room”. The control device determines, based on the orientation reference word “this room”, the target area range as an entire living room range that includes the area range corresponding to the area ID “living room sofa” instead of only the area range corresponding to the area ID “living room sofa”. In this case, the first area range is different from the target area range, and the target area range is a larger range including the first area range.

In an embodiment, as shown in FIG. 13B, after receiving a second control operation “Turn off the lights in other rooms” that is input by the user via voice, the control device extracts semantic information in the second control operation and analyzes the semantic information, determines that the semantic information includes an orientation reference word “other rooms”, and then determines other area ranges than the first area range as the target area range based on the semantic information “other rooms”. In this case, the first area range is different from the target area range, and the target area range does not include the first area range.

In an embodiment, as shown in FIG. 13C, after receiving a second control operation “Turn off the light” that is input by the user via voice, the control device extracts semantic information in the second control operation and analyzes the semantic information, and determines that the semantic information does not include orientation reference information. The control device determines the target area range as the first area range. In this case, the first area range is the same as the target area range.

It can be learned from the foregoing that, when the control device determines the target area range, content related to the orientation reference information in the control instruction of the control device also plays a decisive role. When the control instruction includes the orientation reference information, the control device determines the target area range based on the orientation reference information and the first area range. When the control instruction does not include the orientation reference information, the control device determines the first area range as the target area range.

In addition, in an embodiment, the control instruction input by the user via voice or touch may not include orientation reference information, and includes only a device that needs to be controlled and an action to be performed. However, an area range that the user actually wants to control is not limited to the first area range. For example, the control device responds to a first control operation of tapping a position of the “living room sofa” by the user, and receives a second control operation whose control instruction is “Turn on the light” and that is input by the user via voice or touch. In this case, although the user points to the position of the “living room sofa”, the user intends to control lights in an entire movie watching area to be turned on or adjust the movie watching area to a default lighting mode. In an embodiment, this case is considered as a case in which the control instruction of the second control operation includes “implicit” orientation reference information.

In this case, in an embodiment, the control device may determine the target area range based on different area attributes. The area attribute includes an area and a general area. There is a hierarchical correspondence between the general area and the area. The area is an area that does not have a lower-level area range, for example, a “sofa” or a “dining table”. The general area is an area that includes another sub-area, for example, a “movie watching area” or a “dining area”. The movie watching area may include other sub-areas such as a “sofa”, a “TV cabinet”, or a “coffee table”, and the dining area may include other sub-areas such as a “tea bar area” or a “dining table area”.

For example, FIG. 13D is a diagram of an area range hierarchical relationship according to an embodiment of this application. As shown in the figure, the general area “living room” corresponds to lower-level sub-areas such as the “movie watching area” and the “dining area”, the sub-area “movie watching area” corresponds to lower-level sub-areas such as the “coffee table” and the “TV cabinet”, and the sub-area “dining area” corresponds to lower-level sub-areas such as the “dining table” and a “tea bar machine”. The sub-areas “coffee table”, “TV cabinet”, “dining table”, and “tea bar machine” do not have lower-level area ranges. Therefore, the “coffee table”, the “TV cabinet”, the “dining table”, and the “tea bar machine” may also be referred to as areas. The sub-areas “movie watching area” and “dining area” each include other sub-areas. Therefore, the “movie watching area” and the “dining area” may also be referred to as general areas. In a process in which the control device determines the target area range, when the first area range determined by the control device by using the first control operation is an area, the control device determines an upper-level area range of the first area range as the target area range based on the first area range and the second control operation whose control instruction including the “implicit” orientation reference information. For example, a position tapped by the user is the position of the “sofa”, and the control device determines, based on the area ID “sofa”, that an upper-level area range of the “sofa” is the “movie watching area”. In this case, the control device determines the “movie watching area” as the target area range. When the first area range determined by the control device by using the first control operation is a “general area”, the control device determines the first area range, namely, the “general area”, as the target area range based on the first area range and the second control operation whose control instruction including the “implicit” orientation reference information. For example, the user taps a position next to the sofa. Because projection coordinates corresponding to the position correspond to the area range of the “movie watching area” but do not belong to the area range corresponding to the area ID “sofa”, the control device determines the first area range, namely, the “general area”, as the target area range. In an embodiment, if the user wants to turn on only the light of the “sofa”, the user needs to explicitly input, when performing the second control operation, a control instruction including orientation reference information, for example, “Turn on the light here” or “Brighten here”.

In this manner, the control device can determine whether control needs to be performed only on an electronic device corresponding to an area tapped by the user, and can more accurately determine the target area range.

S505: The control device determines an electronic device in the target area range.

After determining the target area range, the control device may determine, based on the control instruction in the second control operation, an electronic device that finally needs to be controlled and an action that needs to be performed by the electronic device.

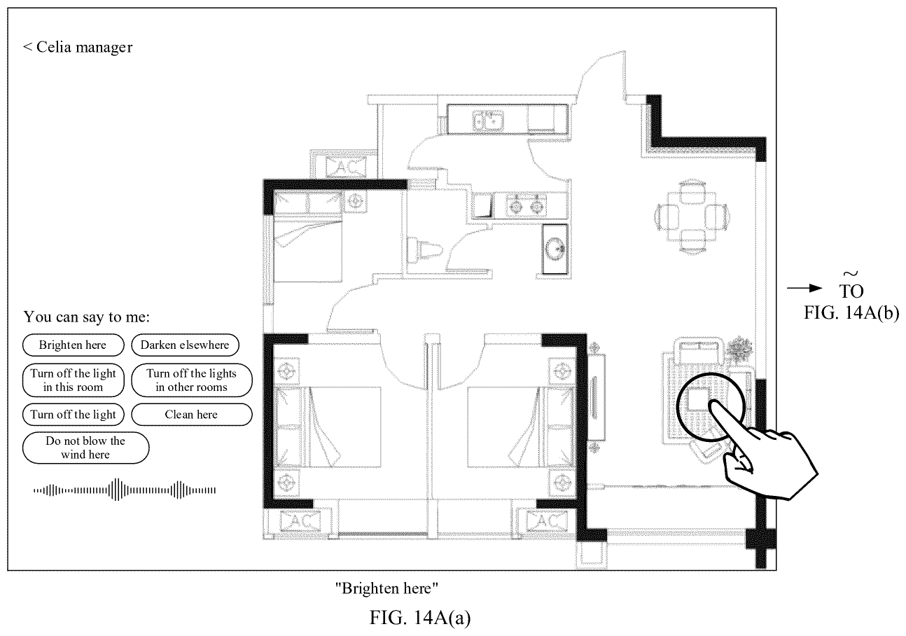

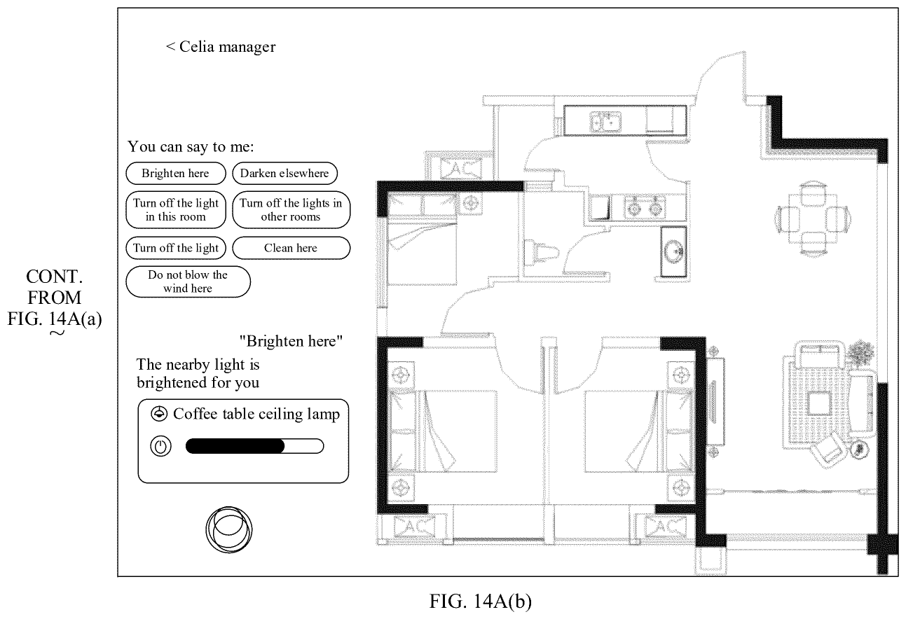

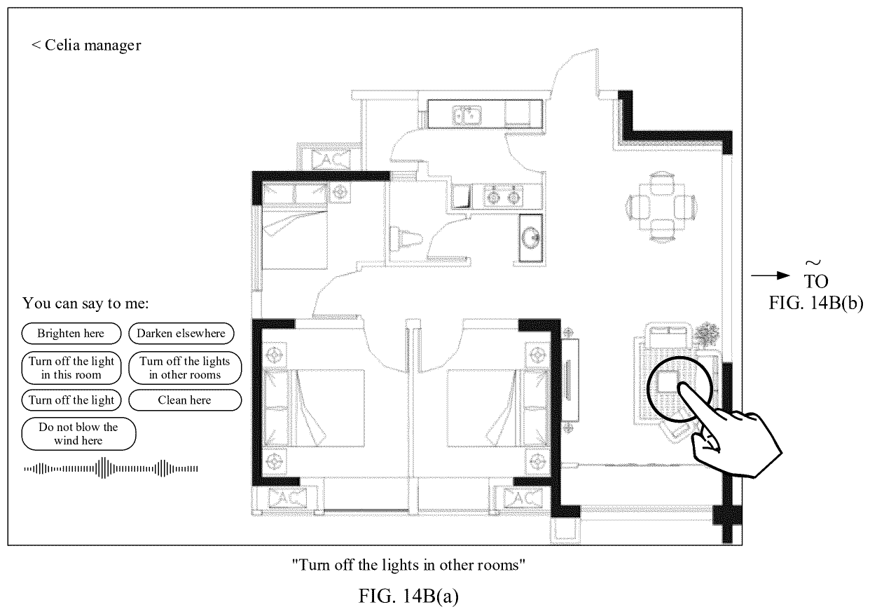

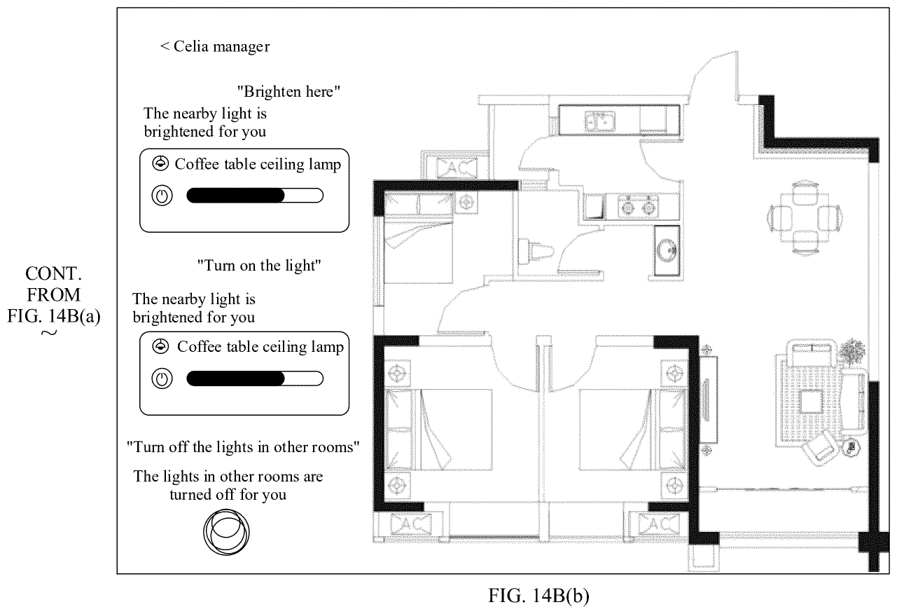

For example, as shown in FIG. 14A(a) and FIG. 14A(b), if the control instruction input by the user via voice is “Brighten here”, the control device determines, based on the control instruction, that an electronic device is “light”, and an action that needs to be performed by the electronic device is “Increase the brightness”. In this case, the control device displays, on the display interface, prompt information “The nearby light is brightened for you” and an element control of a nearby lighting device. The element control may be used to perform secondary adjustment when the user is not satisfied with brightness adjusted by the control device. As shown in FIG. 14B(a) and FIG. 14B(b), if the control instruction input by the user via voice is “Turn off the lights in other rooms”, the control device determines, based on the control instruction, that an electronic device is “light”, and an action that needs to be performed by the electronic device is “Turn off”. In this case, the control device displays, on the display interface, prompt information “The lights in other rooms are turned off for you”. If the control instruction input by the user via voice is “Darken elsewhere”, the control device determines, based on the control instruction, that an electronic device is “light”, and an action that needs to be performed by the electronic device is “Decrease the brightness”. Similarly, the control device may display, on the display interface, prompt information “The lights elsewhere are darkened for you”.

In the method provided in an embodiment, after determining the first area range from the at least one area range in response to the first control operation performed by the user on the spatial information, the control device can more accurately determine, based on the control instruction of the second control operation in this operation, the target area range that needs to be controlled by the user and the electronic device in the target area range. When there are a plurality of electronic devices of a same type or different types in a house of the user, an electronic device that the user needs to control can be determined in this manner.

S506: The control device controls the corresponding electronic device in the target area range based on the second control operation.

In some embodiments, operation S506 includes the following operations S506a and S506b.

S506a: The control device sends an operation instruction to the electronic device.

The operation instruction is used by the electronic device to perform a corresponding operation according to the operation instruction after the electronic device receives the operation instruction. The electronic device is all electronic devices in the target area range, and there may be one or more electronic devices. This is determined based on types and a quantity of electronic devices configured in the target area range.

S506b: The electronic device performs the corresponding operation according to the received operation instruction.

After receiving the operation instruction, the electronic device performs the corresponding operation according to the operation instruction, for example, turns on/off a bedside lamp, or turns on/off an air conditioner.

It should be noted that in some other application scenes, the second control operation input by the user may include a plurality of control instructions. For example, after inputting a first control instruction “Turn off the lights in other rooms” via voice, the user immediately inputs a second control instruction “Turn on the air conditioner” to the control device.

In this case, the control device may first determine a first target area range and an electronic device in the first target area range based on the first area range and the first control instruction in the second control operation, and control, according to the first control instruction, an electronic device in a first target area to perform a corresponding operation. Then, the control device determines a second target area range and an electronic device in the second target area range based on the first area range and the second control instruction in the second control operation, and controls, according to the second control instruction, an electronic device in a second target area to perform a corresponding operation.

According to the device control method provided in an embodiment of the application, the control device can conveniently and quickly control various types of electronic devices in a smart home scene based on a user operation, and can implement both separate control on a single electronic device and centralized control on a plurality of electronic devices. This improves interaction efficiency of selecting a target device and controlling the target device by the user in the smart home scene. The method does not require the user to name each electronic device or define a scene in advance, so that operation costs and preparation costs of the user are reduced, and user experience is improved.

It should be understood that sequence numbers of the operations do not mean an execution sequence in the foregoing embodiments. The execution sequence of the processes should be determined based on functions and internal logic of the processes, and should not constitute any limitation on the implementation processes of embodiments of this application.

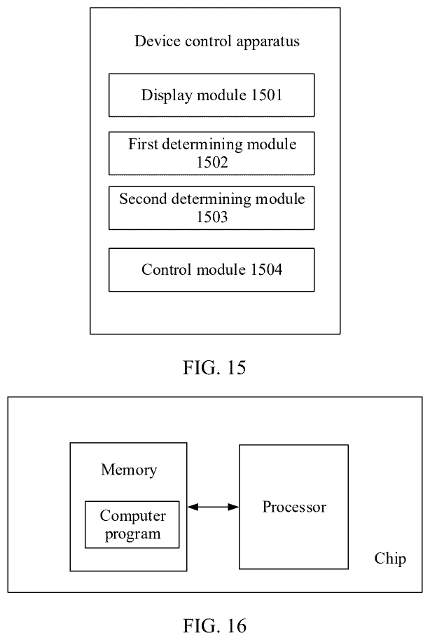

An embodiment of this application further provides a device control apparatus, used in a control device. As shown in FIG. 15, the apparatus includes a display module 1501, a first determining module 1502, a second determining module 1503, and a control module 1504. Functions of the modules are described as follows.

The display module 1501 is configured to display a display interface including spatial information, where the spatial information includes at least one area range.

The first determining module 1502 is configured to determine a first area range from the at least one area range based on a first control operation.

The second determining module 1503 is configured to determine a target area range from the at least one area range based on a second control operation and the first area range, where the first area range is the same as or different from the target area range.

The control module 1504 is configured to control a corresponding electronic device in the target area range based on the second control operation.

An embodiment of this application further provides a control device. The control device includes a memory, a processor, and a computer program that is stored in the memory and that can be run on the processor. When executing the computer program, the processor implements the device control method shown in the foregoing embodiments.

An embodiment of this application further provides a chip. As shown in FIG. 16, the chip includes a processor and a memory. The memory stores a computer program. When the computer program is executed by the processor, the device control method in the foregoing embodiments is implemented.

An embodiment of this application further provides a computer-readable storage medium. The computer-readable storage medium stores a computer program. When the computer program is executed by a processor, the device control method provided in the foregoing embodiments is implemented.

An embodiment of this application further provides a computer program product. The program product includes a computer program. When the computer program is run by a control device, the control device is enabled to implement the device control method provided in the foregoing embodiments.

It should be understood that, the processor mentioned in embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this application may be a volatile memory or a nonvolatile memory, or may include a volatile memory and a nonvolatile memory. The nonvolatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

In embodiments provided in this application, division into the frameworks or modules is merely logical function division and may be other division during actual implementation. For example, a plurality of frameworks or modules may be combined or integrated into another system, or some features may be ignored or not performed.

In addition, functional modules in embodiments of this application may be integrated into one processing module, or each of the modules may exist alone physically, or two or more modules may be integrated into one module. The integrated module may be implemented in a form of hardware, or may be implemented in a form of a software functional module.

It may be clearly understood by one of ordinary skilled in the art that, for the purpose of convenient and brief description, for a detailed operating process of the foregoing system, apparatus, and unit, refer to a corresponding process in the foregoing method embodiments. Details are not described herein again.

Reference to “one embodiment” or “some embodiments” described in the specification of this application means that one or more embodiments of this application include a feature, structure, or characteristic described with reference to the embodiment. Therefore, statements such as “in an embodiment”, “in some embodiments”, “in some other embodiments”, and “in other embodiments” that appear at different places in this specification do not necessarily mean referring to a same embodiment, but mean “one or more but not all of embodiments”, unless otherwise emphasized in another manner. Terms “include”, “contain”, “have”, and their variants all mean “include but are not limited to”, unless otherwise emphasized in another manner.

The foregoing embodiments are merely intended for describing the technical solutions of this application, but not for limiting this application. Although this application is described in detail with reference to the foregoing embodiments, one of ordinary skilled in the art should understand that they may still make modifications to the technical solutions described in the foregoing embodiments or make equivalent replacements to some technical features thereof, without departing from the spirit and scope of the technical solutions of embodiments of this application, and these modifications and replacements shall fall within the protection scope of this application.

1. A device control method applied to a control device, wherein the method comprises:
displaying a display interface comprising spatial information, wherein the spatial information comprises at least one area range;
determining a first area range from the at least one area range based on a first control operation;
determining a target area range from the at least one area range based on a second control operation and the first area range that is the same as or different from the target area range; and
controlling a corresponding electronic device in the target area range based on the second control operation.

2. The method according to claim 1, wherein determining the first area range from the at least one area range based on the first control operation comprises:
determining, based on the first control operation, projection coordinates at which the first control operation is projected onto the spatial information; and
when the projection coordinates have a corresponding area range, determining an area range corresponding to the projection coordinates as the first area range; or
when the projection coordinates have no corresponding area range, determining an area range adjacent to the projection coordinates as the first area range.

3. The method according to claim 1, wherein determining the target area range from the at least one area range based on the second control operation and the first area range comprises:
performing semantic analysis on a control instruction in the second control operation; and
when the control instruction comprises orientation reference information, determining the target area range based on the orientation reference information and the first area range.

4. The method according to claim 3, wherein the method further comprises:
when the control instruction does not comprise the orientation reference information, determining the first area range as the target area range.

5. The method according to claim 3, wherein the method further comprises:
when the control instruction does not comprise the orientation reference information, determining an upper-level area range of the first area range as the target area range.

6. The method according to claim 1, wherein the spatial information comprises:
a floor plan of a residential layout;
a three-dimensional model diagram of a residential layout; or
a three-dimensional model diagram of soft furnishings layout information within a residential environment.

7. The method according to claim 1, wherein the area range comprises:
a dot area range corresponding to the projection coordinates at which the first control operation is projected onto the spatial information;
a two-dimensional area range or a three-dimensional area range corresponding to the projection coordinates at which the first control operation is projected onto the spatial information; or
an area range indicated by area identification information corresponding to the projection coordinates at which the first control operation is projected onto the spatial information.

8. The method according to claim 1, wherein determining the first area range from the at least one area range based on the first control operation comprises:
receiving a selection operation performed by a user on N area ranges in the spatial information;
receiving a cancellation operation performed by the user on M of the N area ranges; and
determining N-M area ranges as the first area range, wherein N≥M≥1.

9. The method according to claim 1, wherein determining the first area range from the at least one area range based on the first control operation further comprises:
receiving a tap operation performed by a user on N area ranges in the spatial information, and determining the N area ranges as the first area range; or
receiving, by the control device, a swiping selection operation performed by the user on a first area in the spatial information, and determining N area ranges comprised in the first area as the first area range, wherein N≥1.

10. The method according to claim 1, wherein after determining the first area range from the at least one area range based on the first control operation, and before determining the target area range from the at least one area range based on the second control operation and the first area range, the method further comprises:
extracting a candidate control instruction related to the first area range; and
displaying an element control of the candidate control instruction on the display interface, wherein the element control indicates a user to input a control instruction based on content corresponding to the element control.

11. The method according to claim 1, wherein the second control operation comprises a voice control operation or a touch control operation.

12. The method according to claim 1, wherein displaying the display interface comprising the spatial information comprises:
determining a position orientation of the control device in a physical space; and
controlling a display direction of the spatial information in a first direction of the control device to be consistent with the position orientation of the control device.

13. The method according to claim 12, wherein the method further comprises:
when the position orientation of the control device in the physical space changes, adjusting the display direction of the spatial information on the display interface of the control device based on a changed position orientation.

14. An electronic device, comprising:
a processor; and
a memory coupled with the processor to store instructions, which when executed by the processor, cause the electronic device to:
display a display interface comprising spatial information, wherein the spatial information comprises at least one area range;
determine a first area range from the at least one area range based on a first control operation;
determine a target area range from the at least one area range based on a second control operation and the first area range that the same as or different from the target area range; and
controlling a corresponding electronic device in the target area range based on the second control operation.

15. The electronic device according to claim 14, wherein to determine the first area range from the at least one area range based on the first control operation, the instructions, when executed, further cause the electronic device to:
determine, based on the first control operation, projection coordinates at which the first control operation is projected onto the spatial information; and
when the projection coordinates have a corresponding area range, determine an area range corresponding to the projection coordinates as the first area range; or
when the projection coordinates have no corresponding area range, determine an area range adjacent to the projection coordinates as the first area range.

16. The electronic device according to claim 14, wherein to determine the target area range from the at least one area range based on the second control operation and the first area range, the instructions, when executed, further cause the electronic device to:
perform semantic analysis on a control instruction in the second control operation; and
when the control instruction comprises orientation reference information, determine the target area range based on the orientation reference information and the first area range.

17. The electronic device according to claim 16, wherein the instructions, when executed, further cause the electronic device to:
when the control instruction does not comprise the orientation reference information, determine the first area range as the target area range.

18. The electronic device according to claim 16, wherein the instructions, when executed, further cause the electronic device to:
when a control instruction does not comprise the orientation reference information, determine an upper-level area range of the first area range as the target area range.

19. The electronic device according to claim 14, wherein the spatial information comprises:
a floor plan of a residential layout;
a three-dimensional model diagram of a residential layout; or
a three-dimensional model diagram of soft furnishings layout information within a residential environment.

20. A non-transitory machine-readable storage medium having instructions stored therein, which when executed by a processor, cause the processor to:
display a display interface comprising spatial information, wherein the spatial information comprises at least one area range;
determine a first area range from the at least one area range based on a first control operation;
determine a target area range from the at least one area range based on a second control operation and the first area range that the same as or different from the target area range; and
controlling a corresponding electronic device in the target area range based on the second control operation.
